(19) United States
(12) Patent Application Publication
(10) Pub. No.: US 2021/0277185 A1
(43) Pub. Date: Sep. 9, 2021

(54) COMPOSITION AND USE THEREOF

(71) Applicant: JSR CORPORATION, Tokyo (JP)

(72) Inventor: Takuya MURAKAMI, Tokyo (JP)

(73) Assignee: JSR CORPORATION, Tokyo (JP)

(21) Appl. No.: 17/325,202

(22) Filed: May 19, 2021

Related U.S. Application Data
(63) Continuation of application No. PCT/JP2019/040132, filed on Oct. 10, 2019.

(30) Foreign Application Priority Data
Dec. 10, 2018 (JP) 2018-230868

(51) Int. Cl. C08G 73/10; C09K 19/12; G02F 1/1335; G02F 1/1337; C09K 19/38; G02B 1/04

(52) U.S. Cl. CPC C08G 73/1007; C09K 19/12; G02F 1/133528; G02F 1/133723; G02F 1/133726; C09K 2219/11; G02B 1/04; C08G 73/1067; C08G 73/1064; C09K 2019/122; C09K 2323/031; C09K 19/3809

(57) ABSTRACT

Provided is a composition, with which it is possible, by means of a simple application process, to form an organic film that has excellent performance, such as optical and electrical properties, and exhibits optical anisotropy. This composition, which exhibits lyotropic liquid crystallinity, contains: a polymer (P) having an acidic functional group; water; and a compound (A) that is at least one selected from the group consisting of a basic monomer and a base-generating agent. The composition contains: a polymer (P) having a partial structure shown in formula (0); water; and a compound (A) that is at least one selected from the group consisting of a basic monomer and a base-generating agent. Formula (0) has at least one acidic functional group.

### CROSS-REFERENCE TO RELATED APPLICATIONS

This application is a continuation application of International Application number PCT/JP2019/040132, filed on Oct. 10, 2019, which claims the priority benefit of Japan Patent Application No. 2018-230868, filed on Dec. 10, 2018. The entirety of each of the above-mentioned patent applications is hereby incorporated by reference herein and made a part of this specification.

### TECHNICAL FIELD

The present disclosure relates to a composition and a use thereof.

### DESCRIPTION OF RELATED ART

Lyotropic liquid crystal polymers are in an isotropic phase in which molecular chains are irregularly arrayed at lower than the critical concentrations, but turn into a liquid crystal phase at the critical concentrations or higher. In this liquid crystal phase, the lyotropic liquid crystal polymer becomes an aggregate of fine domains in which the molecular chains are arrayed in one direction and exhibits optical anisotropy. Furthermore, when a solution of this liquid crystal phase undergoes shear deformation, the molecular chains are aligned in a flow direction. In order to realize lyotropic liquid crystal polymers, it is necessary to use rigid rod-like macromolecules; however, ordinarily, rigid rod-like macromolecules do not easily dissolve in water or organic solvents, which creates a need to use a corrosive solvent such as sulfuric acid or to dissolve the rigid rod-like macromolecules in a polar solvent having a high boiling point at a high temperature.

Among polymers having a bent structure such as polyamides or polyxylylenes, materials ensuring solubility by the introduction of an ionic functional group and exhibiting lyotropic liquid crystallinity under mild conditions have been reported, and the application of such materials to phase difference plates, polarization plates, and the like has been studied (Non-Patent Literature 1 and Patent Literature 1 to 3). In addition, there have been reports on polyimide materials exhibiting lyotropic liquid crystallinity (Non-Patent Literature 2 to 4), and pioneering research regarding the application of polyimide precursors by Neuber et al. has been underway (Non-Patent Literature 5 and 6).

### REFERENCE LIST

### Patent Literature

Patent Literature 1: International Publication WO 2009/130675
Patent Literature 2: International Publication WO 2010/020928
Patent Literature 3: International Publication WO 2010/064194

### Non-Patent Literature

Non-Patent Literature 1: “Langmuir”, 2004, Vol. 20, pp. 6518 to 6520
Non-Patent Literature 2: “Macromolecular Rapid Communications”, 1993, Vol. 14, pp. 395 to 400
Non-Patent Literature 3: “Macromolecules”, 1991, Vol. 24, pp. 1883 to 1889
Non-Patent Literature 4: “Journal of Polymer Science: Part A: Polymer Chemistry (J. Polym. Sci. A Polym. Chem.), 1996, Vol. 34, pp. 587 to 595
Non-Patent Literature 5: “Macromolecular Chemical Physics (Macromol. Chem. Phys.)”, 2002, Vol. 203, pp. 598 to 604
Non-Patent Literature 6: “Advanced Functional Materials (Adv. Funct. Mater.)”, 2003, Vol. 13, pp. 387 to 391

According to a liquid crystal composition containing a lyotropic liquid crystal polymer, there is a likelihood that it may be possible to monoaxially align the polymer by a shear flow at the time of applying the composition onto a base material. Therefore, it is expected that high-performance organic films can be produced by a simple application process. However, in the case of attempting to put lyotropic liquid crystal polymers into practical use as a material for organic films exhibiting optical anisotropy such as a liquid crystal alignment film, a phase difference film, and a polarization film, there is a room for additional improvement in performance such as optical and electrical properties.

The present disclosure has been made in consideration of the above-described problem and an objective of the present disclosure is to provide a composition, with which it is possible, by means of a simple application process, to form an organic film that has excellent performance, such as optical and electrical properties, and exhibits optical anisotropy.

### SUMMARY

According to the present disclosure, the following means is provided.

<1> A composition exhibiting lyotropic liquid crystallinity containing a polymer (P) having an acidic functional group, water, and a compound (A) that is at least one selected from the group consisting of a basic monomer and a base-generating agent.

<2> A composition containing a polymer (P) having a partial structure shown in Formula (0), water, and a compound (A) that is at least one selected from the group consisting of a basic monomer and a base-generating agent.

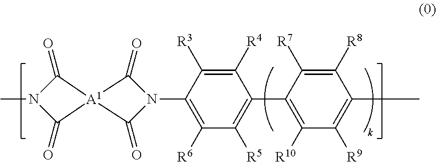

(In Formula (0), A¹ is a partial structure shown in Formula (ar-1) or Formula (ar-2),

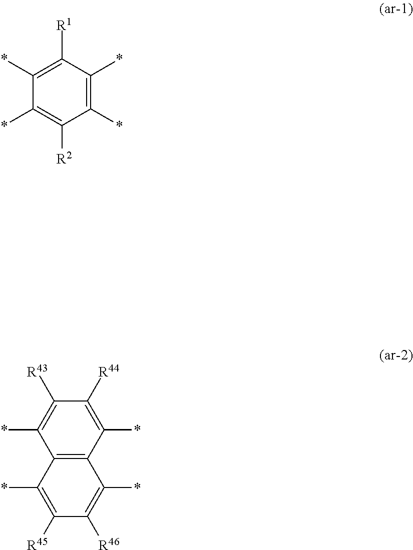

at least one of R¹ to R¹⁰ and R⁴³ to R⁴⁶ is a monovalent group having an acidic functional group, and remainders are each independently a hydrogen atom, a halogen atom, or a monovalent organic group. k is 0 or 1. Here, Formula (0) has at least one acidic functional group.)

<3> A liquid crystal aligning agent exhibiting lyotropic liquid crystallinity containing a polymer (P) having an acidic functional group, water, and a compound (A) that is at least one selected from the group consisting of a basic monomer and a base-generating agent.

<4> A method for producing an organic film including a step of applying the composition according to <1> in a liquid crystal phase state onto a base material and drying the composition in a state in which the polymer (P) is aligned.

<5> A method for producing a patterned liquid crystal alignment film including a step of applying a composition that is the composition according to <1> containing a photosensitive compound in a liquid crystal phase state onto a base material and drying the composition in a state in which the polymer (P) is aligned to form a liquid crystal alignment film, a step of exposing a part of the liquid crystal alignment film, and a step of developing the exposed liquid crystal alignment film.

<6> A liquid crystal alignment film formed using the composition according to <1>.

<7> A polarization plate formed using the composition according to <1>.

<8> A phase difference plate including the liquid crystal alignment film according to <6>.

<9> An liquid crystal antenna that is an array-type liquid crystal antenna having a plurality of antenna units and includes the liquid crystal alignment film according to <6>.

<10> A liquid crystal element including the liquid crystal alignment film according to <6>.

### BRIEF DESCRIPTION OF THE DRAWINGS

FIG. 1 is a view showing a schematic configuration of a liquid crystal display device.

FIG. 2 is a view showing a schematic configuration of a phase difference plate.

FIG. 3 is a view showing a schematic configuration of a polarization plate.

FIG. 4 is a plan view showing a schematic configuration of an array antenna.

FIG. 5 is a cross-sectional view showing a schematic configuration of a part of the array antenna.

FIG. 6 is a ¹H-NMR spectrum of a polymer (PI-1).

FIG. 7 is a ¹H-NMR spectrum of a polymer (PI-2).

FIG. 8 is a ¹H-NMR spectrum of a polymer (PI-4).

FIG. 9 is a ¹H-NMR spectrum of an acidic polymer (PI-1A).

### DESCRIPTION OF THE EMBODIMENTS

<<Composition>>

In one embodiment of the present disclosure, a composition is a composition exhibiting lyotropic liquid crystallinity (hereinafter, also referred to as “lyotropic liquid crystal composition”). The lyotropic liquid crystal composition contains a polymer (P) having an acidic functional group, water, and at least one compound (A) selected from the group consisting of a basic monomer and a base-generating agent. In addition, in one embodiment of the present disclosure, a composition contains a polymer having a partial structure shown in Formula (0), water, and the compound (A). Hereinafter, each component that is contained in the compositions of the present disclosure and other components that are arbitrarily blended as necessary will be described.

It should be noted that “hydrocarbon group” in the present specification refers to a chain-like hydrocarbon group, an alicyclic hydrocarbon group, and an aromatic hydrocarbon group. “Chain-like hydrocarbon group” refers to a linear hydrocarbon group and a branched hydrocarbon group that do not have any cyclic structure in the main chain and have only a chain-like structure. Here, the chain-like hydrocarbon group may or may not be saturated. “Alicyclic hydrocarbon group” refers to a hydrocarbon group that has only an alicyclic hydrocarbon structure as a cyclic structure and does not have an aromatic ring structure. Here, the alicyclic hydrocarbon group does not need to have only an alicyclic hydrocarbon structure and may have a chain-like structure in a part. “Aromatic hydrocarbon group” refers to a hydrocarbon group that has an aromatic ring structure as a cyclic structure. Here, the aromatic hydrocarbon group does not need to have only an aromatic ring structure and may have a chain-like structure or an alicyclic hydrocarbon structure in a part. “Organic group” refers to a group having a hydrocarbon group and may have a heteroatom in the structure.

<Polymer (P)>

The acidic functional group in the polymer (P) is a functional group that forms an ion in water. The acidic functional group is preferably a sulfonic acid group, a phosphonic acid group, a carboxylic acid group, or a salt obtained by neutralizing the above-described group and particularly preferably a sulfonic acid group or a salt thereof since it is possible to further increase the solubility of the polymer (P) in solvents including water.

In a case where the acidic functional group is a salt, examples of the counterion include Li⁺, Na⁺, K⁺, Rb⁺, Cs⁺, Cu⁺, Ag⁺, an ammonium ion, a pyridinium ion, an imidazolium ion, a guanidinium ion, a phosphonium ion, and the like. Here, in a case where the counterion is an inorganic ion, a complex may be formed with an organic ligand, and, in a case where the counterion is an organic ion, the organic ion may be modified by an organic group. In a case where the acidic functional group is a carboxylic acid group, since the acid dissociation constant of a carboxylic acid is low, the proton does not easily dissociate under acidic conditions, and the ionicity decreases, the carboxylic acid group preferably forms a salt with a strong base.

The amount of the acid functional group in the polymer (P) is preferably 50 parts by mole or more and more preferably 100 parts by mole or more with respect to 100 parts by mole of a repeating unit that configures the polymer (P) from the viewpoint of further improving the optical properties and electrical properties of organic films exhibiting optical anisotropy, specifically, the viewpoint of sufficiently imparting solubility and lyotropic liquid crystallinity to the polymer (P). In addition, the upper limit value of the amount of the acidic functional group is not particularly limited and can be arbitrarily set. The content of the acidic functional group is preferably 300 parts by mole or less and more preferably 200 parts by mole or less with respect to 100 parts by mole of the repeating unit that configures the polymer (P) from the viewpoint of easiness in synthesis. It should be noted that the polymer (P) may have one kind of acidic functional group or two or more kinds of acidic functional groups.

As the polymer (P), it is possible to use a water-soluble polymer having liquid crystallinity and capable of self-assembly. The polymer (P) preferably exhibits lyotropic liquid crystallinity in solvents including water. The main chain of the polymer (P) is not particularly limited and examples thereof include polyimide, polyamic acid, polyamic acid ester, polyamide, polyimide-amide, polyxylylene, polyparaphenylene, polyparaphenylene vinylene, polypeptide, cellulose, and the like. Among these, the polymer (P) is preferably a polyimide since the polar anchoring energy with respect to liquid crystals is excellent.

The polymer (P) is preferably a polymer having a partial structure shown in Formula (0) (hereinafter, also referred to as “polymer (PI)”) and particularly preferably a polymer having a partial structure shown in Formula (1) from the viewpoint of exhibiting lyotropic liquid crystallinity under mild conditions in terms of temperatures, solvents, and concentrations. According to a mixture of the polymer (P) and water, it is assumed that the polymer (PI) dissolves in water due to the acidic functional group in the polymer (PI), self-assembly using an excluded volume effect derived from the rigid rod-like skeleton and electrostatic repulsion derived from the acidic functional group as a driving force is accelerated, and the polymer (PI) contributes to the development of liquid crystallinity and an increase in the orientational order parameter even in dilute aqueous solutions.

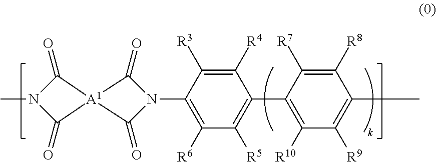

(In Formula (0), A¹ is a partial structure shown in Formula (ar-1) or Formula (ar-2),

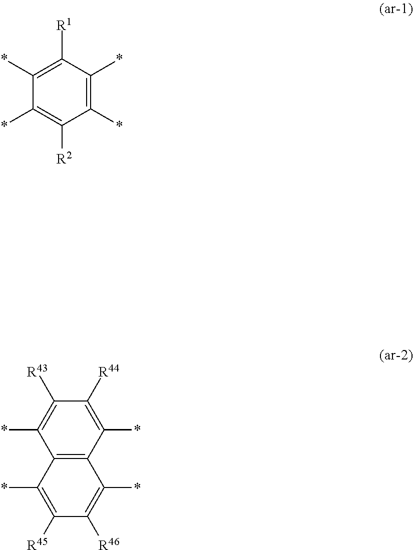

at least one of R¹ to R¹⁰ and R⁴³ to R⁴⁶ is a monovalent group having an acidic functional group, and the remainders are each independently a hydrogen atom, a halogen atom, or a monovalent organic group. k is 0 or 1. Here, Formula (0) has at least one acidic functional group.)

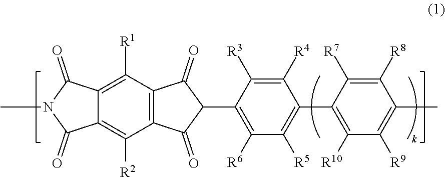

(In Formula (1), at least one of R¹ to R¹⁰ is a monovalent group having an acidic functional group, and the remainders are each independently a hydrogen atom, a halogen atom, or a monovalent organic group. k is 0 or 1. Here, Formula (1) has at least one acidic functional group.)

Regarding R¹ to R¹⁰ and R⁴³ to R⁴⁶ in Formula (0) and Formula (1), the monovalent organic group is preferably a hydrocarbon group and more preferably an alkyl group having 1 to 5 carbon atoms. The monovalent group having an acidic functional group can be represented by “*-L¹-X¹” (here, L¹ is a single bond or a divalent linking group and X¹ is an acidic functional group. “*” represents a bonding site at which an element bonds to the benzene ring.). Here, in a case where L¹ is a divalent linking group, specific examples of L¹ include an alkanediyl group having 1 to 5 carbon atoms, a group having —O— between carbon-carbon bonds of the alkanediyl group, —O—R¹³—** (here, R¹³ is a divalent hydrocarbon group and “**” represents a bonding site at which L¹ bonds to X¹.), and the like. L¹ is preferably a single bond or an alkanediyl group having 1 to 3 carbon atoms and more preferably a single bond.

The number of the acidic functional groups in each of the partial structure shown in Formula (0) and the partial structure shown in Formula (1) is preferably one to four and more preferably one or two. From the viewpoint of the exhibition of favorable lyotropic liquid crystallinity and the viewpoint of a high degree of freedom in the selection of materials, the partial structure shown in Formula (0) and the partial structure shown in Formula (1) preferably have the acidic functional group in a partial structure derived from diamine (that is, at least a part of R³ to R¹⁰). In a case where A¹ is the partial structure shown in Formula (ar-2) in the partial structure shown in Formula (0), k is preferably 0 from the viewpoint of developing liquid crystallinity at a lower polymer concentration.

Preferable specific examples of the partial structure shown in Formula (0) include partial structures shown in Formula (A-1) to Formula (A-8), respectively, and the like. Preferable specific examples of the partial structure shown in Formula (1) include partial structures shown in Formula (A-1) to Formula (A-4), respectively, and the like.

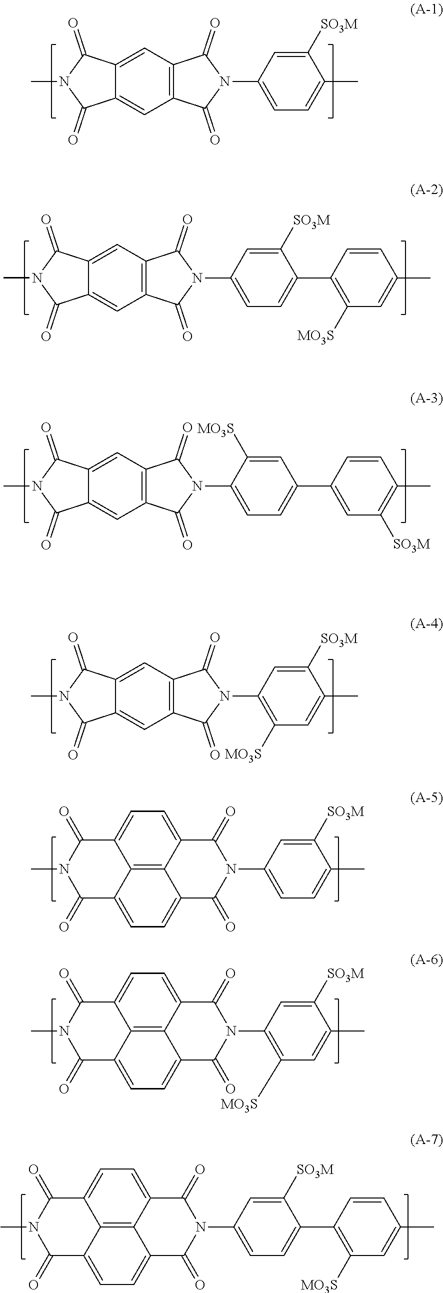

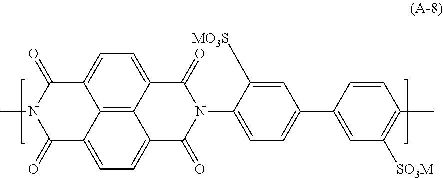

(In Formula (A-1) to Formula (A-8), M is a cation. The plurality of M's in the formulae may be groups that are identical to or different from each other.

As the cation as M, the exemplary examples of the counterion in a case where the acidic functional group is a salt are applied. M is preferably a monovalent cation since it is possible to further increase the solubility of the polymer (P1) in water-based solvents, and particularly, an ammonium ion is preferred and a tertiary ammonium ion is more preferred. The polymer (PI) preferably has at least one selected from the group consisting of the partial structures shown in Formula (A-1) to Formula (A-6), respectively, more preferably has at least one selected from the group consisting of the partial structures shown in Formula (A-1) to Formula (A-4), respectively, and particularly preferably has at least one selected from the group consisting of the partial structure shown in Formula (A-1) and the partial structure shown in Formula (A-2).

In the polymer (P), the content of the partial structure shown in Formula (0) is preferably 50% by mole or more, more preferably 75% by mole or more, and still more preferably 90% by mole or more with respect to the total amount of the repeating units in the polymer (P). The repeating units in the polymer (P) are particularly preferably only the partial structure shown in Formula (0). It should be noted that the repeating unit is the basic unit of the chemical structure of the polymer (P). For example, the repeating unit of the polymer (PI) is a structure that is formed by a reaction between one tetracarboxylic acid derivative and one diamine.

(Synthesis of Polymer (P))

The polymer (P) can be synthesized according to an ordinary method of organic chemistry depending on the main chain. Hereinafter, the polymer (PI) will be described. The polymer (PI) can be obtained by imidizing a polyimide precursor that is obtained by polymerization in which at least one tetracarboxylic acid derivative selected from the group consisting of tetracarboxylic dianhydrides, tetracarboxylic acid diesters, and tetracarboxylic acid diester dihalides and a diamine are used as a raw material composition.

It should be noted that “tetracarboxylic acid diesters” in the present specification refer to compounds in which two of four carboxyl groups in tetracarboxylic acid are esterified and the remaining two carboxyl groups are carboxyl groups. “Tetracarboxylic acid diester dihalides” refer to compounds in which two of four carboxyl groups in tetracarboxylic acid are esterified and the remaining two carboxyl groups are halogenated. As “polyimide precursor”, polyamic acid and polyamic acid esters are included.

At the time of the synthesis of the polymer (1), at least one compound selected from a compound shown in Formula (t-1) and a compound shown in Formula (t-2) (hereinafter, also referred to as “specific acid dianhydride”) is preferably used as the tetracarboxylic dianhydride and the compound shown in Formula (t-1) is more preferably used.

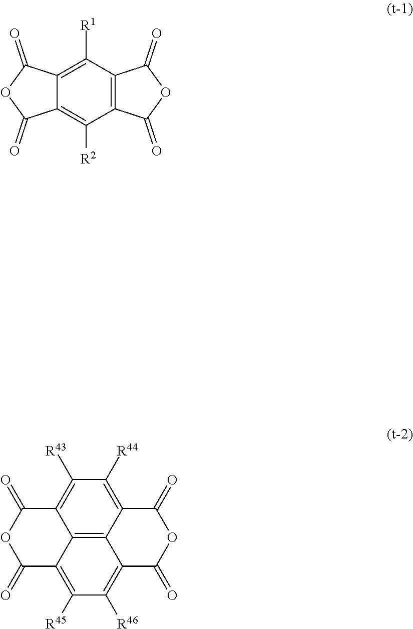

(In Formula (t-1), R¹ and R² are each independently a hydrogen atom, a halogen atom, an acidic functional group, or a monovalent organic group. In Formula (t-2), R⁴³ to R⁴⁶ are each independently a hydrogen atom, a halogen atom, an acidic functional group, or a monovalent organic group.).

As R¹ and R² in Formula (t-1) and R⁴³ to R⁴⁶ in Formula (t-2), examples of the monovalent organic group include hydrocarbon groups having 1 to 20 carbon atoms, groups in which the hydrogen atom in the hydrocarbon group is substituted by an acidic functional group, and the like. Among these, R¹, R², and R⁴³ to R⁴⁶ are preferably a hydrogen atom, a halogen atom, a methyl group, or a trifluoromethyl group and more preferably a hydrogen atom. It should be noted that one kind of specific acid anhydride can be used or two or more kinds of specific acid anhydrides can be used in combination.

Preferred specific examples of the tetracarboxylic acid diester that is used at the time of the synthesis of the polymer (PI) include compounds obtained by opening the ring of the tetracarboxylic dianhydride shown in Formula (t-1) or Formula (t-2) using an alcohol such as methanol or ethanol and the like. Preferred specific examples of the tetracarboxylic acid diester dihalide that is used at the time of the synthesis of the polymer (PI) include compounds obtained by reacting the tetracarboxylic acid diester with a chlorinating agent such as thionyl chloride and the like. It should be noted that one kind of tetracarboxylic acid diester can be used or two or more kinds of tetracarboxylic acid diesters can be used in combination and one kind of tetracarboxylic acid diester dihalide can be used or two or more kinds of tetracarboxylic acid diester dihalides can be used in combination.

As the diamine at the time of the synthesis of the polymer (PI), a diamine having an acidic functional group (hereinafter, also referred to as “specific diamine”) is preferably used, and an aromatic diamine having an acidic functional group is more preferably used. Preferred specific examples of the specific diamine include compounds shown in Formulae (d-1) to (d-9), respectively. It should be noted that one kind of specific diamine can be used or two or more kinds of specific diamines can be used in combination.

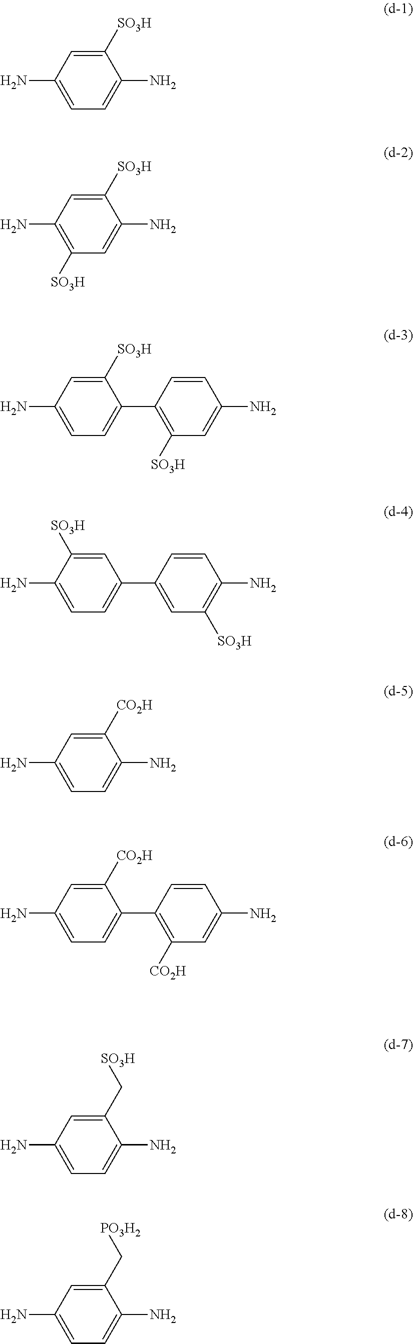

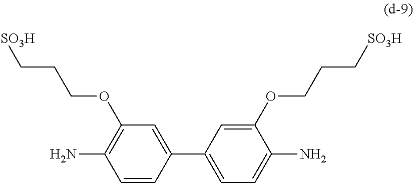 [SMILES: Nc1ccc(-c2ccc(N)c(OCCCS(=O)(=O)O)c2)cc1OCCCS(=O)(=O)O]

[Polyamic Acid]

Polyamic acid that is a precursor of the polymer (PI) (hereinafter, also referred to as “polyamic acid (P)”) can be obtained by, for example, reacting a tetracarboxylic acid dianhydride and a diamine. Specific examples thereof include [i] a method in which a tetracarboxylic acid dianhydride and a diamine are directly reacted with each other; [ii] a method in which a tetracarboxylic acid dianhydride or a diamine is neutralized with a base and then the tetracarboxylic acid dianhydride and the diamine are reacted with each other, and the like.

At the time of the synthesis of the polymer (PI), it is also possible to jointly use a tetracarboxylic dianhydride other than the specific acid dianhydride (hereinafter, also referred to as “different acid dianhydride”) or a diamine other than the specific diamine (hereinafter, also referred to as “different diamine”).

(Different Acid Anhydride)

Examples of the different dianhydride include aliphatic tetracarboxylic dianhydrides, alicyclic tetracarboxylic dianhydrides, aromatic tetracarboxylic dianhydrides, and the like. As specific examples thereof, examples of the aliphatic tetracarboxylic dianhydrides include butanetetracarboxylic dianhydride, ethylenediaminetetraacetic dianhydride, and the like; examples of the alicyclic tetracarboxylic dianhydrides include 1,2,3,4-cyclobutanetetracarboxylic anhydride, 1,2,4,5-cyclohexanetetracarboxylic dianhydride, and the like; and examples of the aromatic tetracarboxylic dianhydrides include naphthalene-2,3,6,7-tetracarboxylic dianhydride, 4,4′-biphthalic dianhydride, and the like, respectively. In addition, it is also possible to use tetracarboxylic anhydrides described in Japanese Unexamined Patent Application Publication No. 2010-97188. It should be noted that one kind of different acid anhydride can be used or two or more kinds of different acid anhydrides can be used in combination.

(Different Diamine)

Examples of the different diamine include aliphatic diamines, alicyclic diamines, aromatic diamines, diaminoorganosiloxane, and the like. As specific examples thereof, examples of the aliphatic diamines include metaxylylenediamine, hexamethylenediamine, and the like; examples of the alicyclic diamines include 1,4-diaminocyclohexane, 4,4′-methylenebis(cyclohexylamine), and the like, examples of the aromatic diamines include p-phenylenediamine, 2,4-diaminobenzenesulfonic acid, 3,5-diaminobenzoic acid, 4,4′-diaminostilbene-2,2′-disulfonic acid, 2,2′-dimethyl-4,4′-diaminobiphenyl, and the like; and examples of the diaminoorganosiloxane include 1,3-bis(3-aminopropyl)-tetramethyldisiloxane, and the like, respectively. In addition, it is also possible to use diamines described in Japanese Unexamined Patent Application Publication No. 2010-97188.

At the time of the synthesis of the polyamic acid (P), in a case where lyotropic liquid crystallinity is imparted to the polyamic acid (P) using the specific acid dianhydride, the proportion of the specific acid dianhydride used is preferably set to 50% by mole or more, more preferably set to 75% by mole or more, and particularly preferably set to 90% by mole or more with respect to the total amount of the tetracarboxylic dianhydride that is used for the synthesis of the polyamic acid (P) from the viewpoint of sufficiently imparting lyotropic liquid crystallinity to the polyamic acid (P). The upper limit of the proportion of the specific acid dianhydride used is not particularly limited and can be arbitrarily set within a range of 100% by mole or less.

The proportion of the specific diamine used is preferably set to 50% by mole or more, more preferably set to 75% by mole or more, still more preferably set to 90% by mole or more, and particularly preferably set to 100% by mole with respect to the total amount of the diamine that is used for the synthesis of the polyamic acid (P) from the viewpoint of sufficiently imparting solubility in water-based solvents and lyotropic liquid crystallinity to the polyamic acid (P).

(Synthesis of Polyamic Acid)

The polyamic acid (P) can be obtained by reacting the above-described tetracarboxylic dianhydride and the above-described diamine together with a molecular weight modifier as necessary. The proportion of the tetracarboxylic dianhydride and the diamine used, which are subjected to the synthesis reaction of the polyamic acid (P), is a proportion at which the acid anhydride group of the tetracarboxylic acid dianhydride preferably reaches 0.5 to 2 equivalents and more preferably reaches 0.8 to 1.2 equivalents with respect to 1 equivalent of the amino group of the diamine.

In a case where a monomer having an acidic functional group is neutralized with a base and then the tetracarboxylic acid dianhydride and the diamine are reacted with each other (the case of the method (ii)), a variety of bases can be used, but an organic base is preferred, a tertiary amine is more preferred, and triethylamine is particularly preferred from the viewpoint of securing solubility in organic solvents. The proportion of the base used is preferably a portion of 0.5 to 5 equivalents and more preferably a portion of 1 to 2 equivalents with respect to the acidic functional group. Examples of the molecular weight modifier include acid monoanhydrides such as maleic anhydride, phthalic anhydride, and itaconic anhydride, monoamine compounds such as aniline, cyclohexylamine, and n-butylamine, monoisocyanate compounds such as phenylisocyanate and naphthylisocyanate, and the like. The proportion of the molecular weight modifier used is preferably 20 parts by mass or less and more preferably 10 parts by mass or less with respect to a total of 100 parts by mass of the tetracarboxylic dianhydride and the diamine used.

The synthesis reaction of the polyamic acid (P) is preferably performed in an organic solvent. The reaction temperature is preferably −20° C. to 150° C. and more preferably 0° C. to 100° C. In addition, the reaction time is preferably 0.1 to 24 hours and more preferably 0.5 to 12 hours.

Examples of the organic solvent that is used for the reaction include aprotic polar solvents, phenolic solvents, alcohols, ketones, esters, ethers, halogenated hydrocarbons, hydrocarbons, and the like. Among these organic solvents, it is preferable to use one or more selected from the group consisting of aprotic polar solvents and phenolic solvents (first group of organic solvents) or a mixture of one or more selected from the first group of organic solvents and one or more selected from the group consisting of alcohols, ketones, esters, ethers, halogenated hydrocarbons, and hydrocarbons (second group of organic solvents). In the latter case, the proportion of the second group of organic solvents used is preferably 50% by mass or less, more preferably 40% by mass or less, and still more preferably 30% by mass or less with respect to the total amount of the first group of organic solvents and the second group of organic solvents.

As a particularly preferred organic solvent, one or more selected from the group consisting of N-methyl-2-pyrrolidone, N,N-dimethylacetamide, N,N-dimethylformamide, dimethyl sulfoxide, γ-butyrolactone, tetramethylurea, hexamethylphosphorotriamide, m-cresol, xylenol, and halogenated phenol is used as the solvent or a mixture of one or more of the above-described organic solvents and a different organic solvent is preferably used within the above-described proportion range. The amount of the organic solvent used (a) is preferably set to an amount at which the total amount of the tetracarboxylic dianhydride and the diamine (b) reaches 1% to 50% by mass with respect to the total amount (a+b) of the reaction solution. The reaction solution containing the polyamic acid (P) may be subjected to a dehydration and ring-closing reaction as it is or may be subjected to a dehydration and ring-closing reaction after isolating the polyamic acid (P).

[Polyamic Acid Ester]

The polyamic acid ester that is a precursor of the polymer (PI) (hereinafter, also referred to as “polyamic acid ester (P)”) can be obtained by, for example, [I] a method in which polyamic acid (P) obtained by the above-described polymerization reaction and an esterification reagent are reacted with each other, [II] a method in which a tetracarboxylic acid diester and a diamine are reacted with each other, [III] a method in which a tetracarboxylic acid diester dihalide and a diamine are reacted with each other, or the like.

[Imidization]

The polymer (PI) can be obtained by imidizing a polyimide precursor synthesized as described above by dehydration and ring closing. The polymer (PI) may be a fully imidized substance in which the amic acid structures or the amic acid ester structures in a polyimide precursor, which is a precursor of the polymer (PI), are all dehydrated and ring-closed or may be a partially imidized substance in which only a part of the amic acid structures and the amic acid ester structures are dehydrated and ring-closed and the amic acid structures or the amic acid ester structures and imide ring structures coexist. From the viewpoint of obtaining organic films having a sufficiently high polar anchoring energy and a sufficiently high voltage holding ratio in the use of liquid crystal elements, the imidization rate of the polymer (PI) is preferably 50% or more, more preferably 75% or more, still more preferably 90% or more, and particularly preferably 95% or more. This imidization rate is the proportion of the number of the imide ring structures in the total of the number of the amic acid structures and the amic acid ester structures and the number of the imide ring structures in the polyimide that is expressed as a percentage.

The dehydration and ring closing of the polyimide precursor are preferably performed by a method in which the polyamic acid is heated or by a method in which polyamic acid is dissolved in an organic solvent, at least any of a dehydrating agent and a dehydration and ring-closing catalyst is added to the solution, and the solution is heated as necessary.

In the method in which a dehydrating agent and a dehydration and ring-closing catalyst are added to the solution of polyamic acid, as the dehydrating agent, it is possible to use, for example, an acid anhydride such as an acetic anhydride, a propionic anhydride, or a trifluoroacetic anhydride. The amount of the dehydrating agent used is preferably set to 0.01 to 20 moles with respect to 1 mole of the amic acid structures of the polyamic acid. As the dehydration and ring-closing catalyst, it is possible to use, for example, a basic catalyst such as pyridine, triethylamine, or 1-methylpiperidine or an acid catalyst such as methanesulfonic acid or benzoic acid. The amount of the dehydration and ring-closing catalyst used is preferably set to 0.01 to 10 moles with respect to 1 mole of the dehydrating agent used. Examples of the organic solvent that is used in the dehydration and ring-closing reaction include the organic solvents exemplified as the organic solvent that is used for the synthesis of the polyamic acid (P). The reaction temperature of the dehydration and ring-closing reaction is preferably 0° C. to 200° C., and the reaction time is preferably 1.0 to 120 hours. The reaction solution containing the polymer may be used for the preparation of a composition as it is or may be used for the preparation of a composition after isolating the polymer.

[Physical Properties of Polymer (P)]

The polymer (P) preferably has a solution viscosity of 10 to 2000 mPa·s and more preferably has a solution viscosity of 20 to 1000 mPa·s when a solution having a concentration of 10% by mass is prepared using the polymer (P). It should be noted that the solution viscosity (mPa·s) of the polymer is a value measured at 25° C. using an E-type rotational viscometer from a polymer solution having a concentration of 10% by mass that is prepared using a good solvent (for example, water or the like) for the polymer.

The polystyrene-equivalent weight-average molecular weight (M_{w}) measured by the gel permeation chromatography of the polymer (P) is preferably 1,000 or more and more preferably 2,000 or more. In addition, M_{w} is preferably 500,000 or less and more preferably 100,000 or less. The molecular weight distribution (M_{w}/Mₙ) that is expressed as the ratio of M_{w} to the polystyrene-equivalent number-average molecular weight (Mₙ) measured by GPC is preferably 10 or less and more preferably 5 or less. Within such a molecular weight range, it is possible to facilitate the ensuring of a concentration range and a temperature range within which the composition exhibits lyotropic liquid crystallinity.

The polymer (P) preferably exhibits lyotropic liquid crystallinity in at least a part of temperatures in a range of 0° C. or higher and lower than 100° C. The temperature range in which the polymer (P) exhibits lyotropic liquid crystallinity is, within the range of 0° C. or higher and lower than 100° C., preferably a temperature range including 20° C. to 40° C., more preferably a temperature range including 20° C. to 60° C., and still more preferably a temperature range including 20° C. to 80° C.

<Water>

The present composition is a liquid-phase composition containing the water-soluble polymer (P) dissolved in a water-based solvent. The proportion of water contained is preferably 40% by mass or more, more preferably 60% by mass or more, and still more preferably 80% by mass or more with respect to the total amount (100% by mass) of the solvent that is contained in the composition from the viewpoint of making the acidic functional group in the polymer (P) dissociate to have a charge, induce electrostatic repulsion between molecules, and develop liquid crystallinity even at low concentrations. The proportion of water contained can be set to 100% by mass or less with respect to the total amount of the solvent that is contained in the composition.

<Compound (A)>

(Basic Monomer)

The basic monomer needs to be a water-soluble compound having a polymerizable group and a basic functional group, and the other structures are not particularly limited. The polymerizable group in the basic monomer is preferably a radical polymerizable group and more preferably a group having a carbon-carbon unsaturated bond. A (meth)acryloyl group or a vinyl group is particularly preferred. It should be noted that “(meth)acryloyl” in the present specification refers to “acryloyl” and “methacryloyl”.

The basic functional group is a functional group capable of acid-base interaction with the acid functional group in the polymer (P). The basic functional group in the basic monomer and the acidic functional group in the polymer (P) interact to form a polyion complex in films, whereby it is possible to improve the optical properties and water resistance of liquid crystal alignment films. In addition, it is possible to improve the electrical properties of liquid crystal elements. The basic functional group is preferably a functional group having a nitrogen atom. It should be noted that the basic functional group may be protonated or alkylated in the composition or may become a counterion of the acidic functional group in the polymer (P).

Specific examples of a case where the basic functional group is a functional group having a nitrogen atom include a primary amino group (—NH₂), a secondary amino group (—NRH²⁰), a tertiary amino group (—NR²¹R²²), a pyridyl group, an imidazolyl group, a guanidino group, and the like. Here, R²⁰, R²¹, and R²² are each independently a monovalent hydrocarbon group having 1 to 10 carbon atoms. R²⁰, R²¹, and R²² are each preferably an alkyl group having 1 to 5 carbon atoms. Among these, the basic functional group is preferably a group that is an acyclic structure from the viewpoint of enabling the liquid crystal alignment property of the polymer (P) to be superior and more preferably a tertiary amino group from the viewpoint of enabling the preservation stability of the composition to be favorable.

The number of the basic functional groups in the basic monomer may be one or plural. The number of the basic functional groups in one molecule of the basic monomer is preferably one or two and more preferably one since it is possible to obtain liquid crystal elements exhibiting an excellent liquid crystal alignment property and excellent electrical properties by appropriately forming an ion cross-link in films. It should be noted that a monofunctional basic monomer and a multifunctional basic monomer may be jointly used.

As the basic monomer, it is possible to preferably use at least one selected from the group consisting of a (meth)acryloyl group-containing compound and a vinyl group-containing compound. Among these, the (meth)acryloyl group-containing compound is more preferred and a compound shown in Formula (5) can be particularly preferably used.

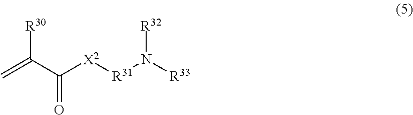

(In Formula (5), R³⁰ is a hydrogen atom or a methyl group, and X² is —NH— or —O—. R³¹ is a divalent alkanediyl group having 2 to 10 carbon atoms, and R³² and R³³ are each independently a hydrogen atom or an alkyl group having 1 to 5 carbon atoms or are a ring structure that is made up of R³² and R³³ joined together in conjunction with a nitrogen atom to which R³² and R³³ bond.

In Formula (5), R³¹ is preferably linear. The number of carbon atoms in R³¹ is preferably 2 to 8 and more preferably 2 to 5. Examples of the ring structure that is made up of R³² and R³³ joined together include a pyrrolidine ring, a piperidine ring, a morpholine ring, and the like.

Specific examples of the basic monomer include compounds shown in Formula (4-1) to Formula (4-6), respectively, and the like. It should be noted that one kind of basic monomer can be used or two or more kinds of basic monomers can be used in combination.

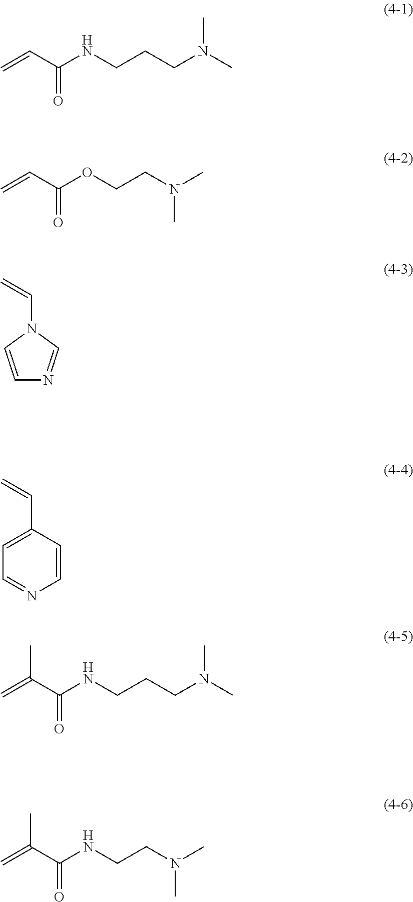

In the composition, the proportion of the basic monomer blended is preferably 0.2 mole equivalents or more, more preferably 0.5 mole equivalents or more, and still more preferably 0.8 mole equivalents or more with respect to the total amount of the acidic functional group in the polymer (P) from the viewpoint of sufficiently obtaining an effect of improving the liquid crystal alignment property and electrical properties of liquid crystal elements. In addition, the proportion of the basic monomer blended is preferably 2.0 mole equivalents or less, more preferably 1.5 mole equivalents or less, and still more preferably 1.0 mole equivalent or less with respect to the total amount of the acidic functional group in the polymer (P) from the viewpoint of suppressing performance degradation due to the excessive generation of a basic polymer.

(Base-Generating Agent)

The base-generating agent is a compound that generates a base by being imparted with at least one of heat and light. As the base-generating agent, it is possible to preferably use a thermal base-generating agent from the viewpoint of easiness in procuring, and examples thereof include a multifunctional compound having a plurality of basic functional groups that may be protected (hereinafter, also referred to as “multifunctional base”), an ion-type base, and the like. The basic functional group in the multifunctional base is a functional group capable of acid-base interaction with the acid functional group in the polymer (P). The multifunctional base is preferably a compound containing a nitrogen atom and more preferably a compound shown in Formula (2).

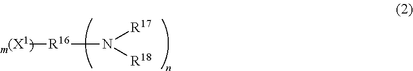

(In Formula (2), R¹⁶ is a (m+n)-valent organic group, R¹⁷ is a protective group, R¹⁸ is a hydrogen atom or a monovalent organic group, and X¹ is a monovalent group having a basic functional group including a nitrogen atom. Here, R¹⁸ and X¹ may be joined together to form a ring structure in conjunction with an atom to which R¹⁸ and X¹ bond. m is 0 or 1, n is an integer of one or larger, and m+n≥2 is satisfied.)

Examples of R¹⁷ in Formula (2) include a carbamate-based protective group, an amide-based protective group, an imide-based protective group, a sulfonamide-based protective group, and the like. Among these, the carbamate-based protective group is preferred, and specific examples thereof include tert-butoxycarbonyl group, benzyloxycarbonyl group, 1,1-dimethyl-2-haloethyloxycarbonyl group, 1,1-dimethyl-2-cyanoethyloxycarbonyl group, 9-fluorenylmethylcarbonyl group, 2-(trimethylsilyl)ethoxycarbonyl group, and the like. From the viewpoint of easiness in deprotection by heat or the viewpoint of enabling a compound derived from a group desorbed by heating during the formation of a film to be discharged as gas to the outside of the film, tert-butoxycarbonyl group is preferred.

Examples of the monovalent organic group as R¹⁸ include a hydrocarbon group having 1 to 10 carbon atoms, a protective group, and the like. R¹⁸ is preferably a hydrogen atom, an alkyl group having 1 to 3 carbon atoms, or tert-butoxycarbonyl group. Examples of R¹⁶ include a divalent hydrocarbon group having 1 to 20 carbon atoms, a group having —O— between carbon-carbon bonds of a hydrocarbon group having 2 to 20 carbon atoms, a group in which a hydrogen atom of a divalent hydrocarbon group having 1 to 20 carbon atoms is substituted with a substituent such as —OH or —COOH, and the like. R¹⁶ is preferably a divalent hydrocarbon group having 1 to 20 carbon atoms or a group having —OH or —COOH as a substituent. Examples of X¹ include an amino group, a pyridyl group, an imidazolyl group, a guanidino group, and the like. m is preferably one from the viewpoint of developing acid-base interaction with the polymer (P). n is preferably one to four and more preferably one or two.

As specific examples of the base-generating agent, examples of the multifunctional base include compounds shown in Formula (2-1) to Formula (2-6), respectively, and the like; examples of the ion-type base include compounds shown in Formula (3-1) and the like. Among these, the multifunctional base is preferably used from the viewpoint of an effect of improving the dynamic properties and water resistance of liquid crystal alignment films and the electrical properties of liquid crystal elements.

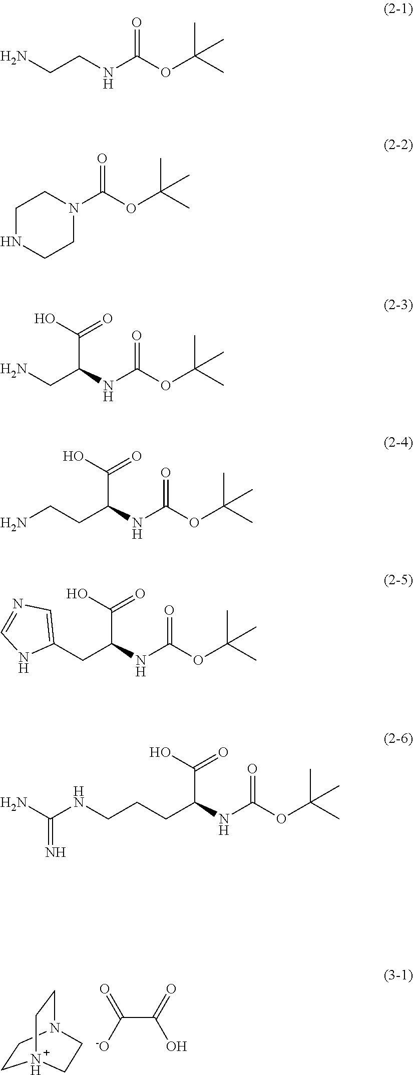

In the composition, the proportion of the base-generating agent blended is a proportion at which the basic functional group in the base-generating agent preferably reaches 0.2 mole equivalents or more, more preferably reaches 0.5 mole equivalents or more, and still more preferably reaches 0.8 mole equivalents or more with respect to the total amount of the acidic functional group in the polymer (P) that is contained in the composition from the viewpoint of sufficiently obtaining an effect of improving the electrical properties of liquid crystal elements. In addition, the proportion of the base-generating agent blended is a proportion at which the basic functional group in the base-generating agent preferably reaches 2.0 mole equivalents or less, more preferably reaches 1.5 mole equivalents or more, and still more preferably reaches 10 mole equivalents or more with respect to the total amount of the acidic functional group in the polymer (P) that is contained in the composition from the viewpoint of suppressing performance degradation due to the excessive formation of a cross-link.

<Other Components>

The present composition may contain components other than the polymer (P), water, and the compound (A) to an extent that the objective and effect of the present disclosure are not hindered.

[Polymerization Initiator]

In a case where the composition contains the basic monomer as the compound (A), the composition preferably further contains a polymerization initiator. As the polymerization initiator, it is possible to use a water-soluble thermal polymerization initiator and a water-soluble photopolymerization initiator. As specific examples thereof, examples of the water-soluble thermal polymerization initiator include 4,4′-azobis(4-cyanovaleric acid), 2,2′-azobis[2-(2-imidazolin-2-yl)propane] disulfate dihydrate, 2,2′-azobis[2-(2-imidazolin-2-yl)propane] dihydrochloride, 2,2′-azobis(2-methylpropionamidine) dihydrochloride, 2,2′-azobis[N-(2-carboxyethyl)-2-methylpropionamidine] tetrahydrate, 2,2′-azobis[2-(2-imidazolin-2-yl)propane], 2,2′-azobis[2-methyl-N-(2-hydroxyethyl)propionamide], and the like; examples of the water-soluble photopolymerization initiator include lithium phenyl(2,4,6-trimethylbenzoyl)phosphinate, 2-hydroxy-4′-(2-hydroxyethoxy)-2-methylpropiophenone, and the like. One kind of polymerization initiator may be used singly or two or more kinds of polymerization initiators may be used in combination.

The proportion of the polymerization initiator blended is preferably 0.001% by mass or more and more preferably 0.01% by mass or more with respect to the total amount of the composition from the viewpoint of sufficiently progressing the polymerization of the basic monomer in films. In addition, the proportion of the polymerization initiator blended is preferably 1.0% by mass or less and more preferably 0.10% by mass or less with respect to the total amount of the composition.

[Different Polymer]

The composition may contain a polymer different from the polymer (P) (hereinafter, also referred to as “different polymer”). Examples of the different polymer include polyamic acid that is obtained by reacting the different tetracarboxylic dianhydride and the different diamine, an imidized polymer of the polyamic acid, an esterified polymer of the polyamic acid, a polyester, a polyamide, a cellulose derivative, a polyacetal, a polystyrene derivative, a poly(styrene-phenylmaleimide) derivative, a poly(meth)acrylate, and the like. It should be noted that “(meth)acrylate” refers to “acrylate” and “methacrylate”. In the case of blending the different polymer into the composition, the proportion of the different polymer blended is preferably 30 parts by mass or less, more preferably 10 parts by mass or less, and still more preferably 5 parts by mass or less with respect to a total of 100 parts by mass of the polymers that are contained in the composition.

[Rod-Like Molecule or the Like]

The composition may contain a rod-like molecule or a rod-like nanostructure (hereinafter, also referred to as “rod-like molecule or the like”). The alignment of the rod-like molecule or the like can also be controlled in accordance with the monoaxial alignment of the polymer (P) by applying shear stress to the composition. Examples of the rod-like molecule include a dichroic pigment, and examples of the rod-like nanostructure include a pigment aggregate, a quantum rod, a metal nanorod, a carbon nanotube, a protein, a nucleic acid, a virus, and the like. With the control of the alignment of the rod-like molecule or the like, it is possible to impart a variety of functionalities, and, among them, at least one selected from the group consisting of a dichroic pigment, a pigment aggregate, a quantum rod, a metal nanorod, and a carbon nanotube can be preferably used. For example, according to the composition containing a dichroic pigment, it is possible to form guest-host polarization plates. According to the composition containing a quantum rod, it is possible to form wavelength conversion plates capable of polarized emission, and, according to the composition containing the carbon nanotube, it is possible to form wires or actuators having conduction anisotropy. The proportion of the rod-like molecule or the like blended into the composition can be appropriately set depending on the kind of the rod-like molecule or the like to an extent that the effect of the present disclosure is not impaired.

[Solvent]

As a solvent component of the present composition, a solvent other than water (hereinafter, also referred to as “different solvent”) may be used. The different solvent may be any solvent that can be homogeneously mixed with water, and examples thereof include methanol, ethanol, n-propanol, i-propanol, n-butanol, ethylene glycol, acetone, methyl ethyl ketone, tetrahydrofuran, N-methyl-2-pyrrolidone, γ-butyrolactone, 1-butoxy-2-propanol, diacetone alcohol, dipropropylene glycol monomethyl ether, ethyl lactate, ethylene glycol methyl ether, ethylene glycol-n-butyl ether (butyl cellosolve), diethylene glycol monomethyl ether, diethylene glycol monoethyl ether, diethylene glycol monomethyl ether acetate, diethylene glycol monoethyl ether acetate, and the like. One kind of different solvent may be used singly or two or more kinds of different solvents may be used in combination.

In the case of using a solvent mixture of water and an organic solvent as the solvent, the organic solvent that is used is preferably an organic solvent having a lower boiling point than water and more preferably at least one selected from the group consisting of methanol, ethanol, n-propanol, i-propanol, acetone, and tetrahydrofuran. In the case of using the solvent mixture of water and the organic solvent, the proportion of the organic solvent contained is preferably set to 50% by mass or less, more preferably 25% by mass or less, and still more preferably 10% by mass or less with respect to the total amount of the solvent mixture.

Examples of the other components aside from the above-described components include a compound having at least one epoxy group in the molecule, a functional silane compound, a surfactant, a filler, a colorant, a defoamer, a sensitizer, a dispersant, an antioxidant, an adhesion aid, an antistatic agent, a leveling agent, an antibacterial agent, and the like. It should be noted that the portion of the other components blended can be appropriately set depending on each compound that is blended to an extent that the effect of the present disclosure is not hindered.

The concentration of the polymer (P) in the composition is preferably a concentration at which the composition exhibits lyotropic liquid crystallinity. The concentration of the polymer (P) is preferably 10% to 20% by mass with respect to the total amount of the solvent and the polymer (P). The concentration of the polymer (P) is more preferably 1% to 10% by mass and still more preferably 1% to 5% by mass with respect to the total amount of the solvent and the polymer (P). The polymer (PI) is particularly preferred since it is possible to obtain the composition exhibiting lyotropic liquid crystallinity at a relatively low concentration of the polymer. Therefore, the application property at the time of forming coatings on base materials is favorable, thin films having a film thickness of approximately 0.05 to 0.5 μm can be produced, and the industrial productivity is excellent.

The solid solution concentration of the composition (the proportion of the total mass of the components aside from the solvent in the composition in the total mass of the composition) is appropriately selected in consideration of the viscous property, the volatility, or the like and is within a range of preferably 1% to 30% by mass, more preferably 1% to 20% by mass, and particularly preferably 1% to 10% by mass. There is a case where the present composition is applied onto the surface of a base material as described below and, preferably, dried to form coatings. At this time, when the solid solution concentration is 1% by mass or higher, it becomes easy for the composition to exhibit lyotropic liquid crystallinity, which is preferable. In addition, when the solid solution concentration is 30% by mass or lower, there is a tendency that the film thickness of a coating becomes an appropriate thickness, which facilitates the obtainment of a favorable coating, and the viscous property of the composition becomes appropriate, which enables the application property to be favorable. The temperature at the time of preparing the composition is preferably 10° C. to 90° C. and more preferably 20° C. to 80° C.

<Method for Producing Organic Film>

The use of the above-described composition enables an optically anisotropic organic film to be obtained. For the organic film, the present composition is applied onto a base material in a liquid crystal phase state and dried in a state in which the composition is caused to flow by shear stress (application and drying step). Therefore, it is possible to obtain a coating in which the molecular chains of the polymer (P) are monoaxially aligned in the shear direction in a self-assembly manner. The composition is preferably applied by a bar coater method, an applicator method, a die coater method, or a blade coater method. These methods are preferred since it is easy to align the molecular chains of the polymer (P) by a flow induced by shear stress.

The heating temperature is preferably set to a temperature close to or higher than the boiling point of water. A specific heating temperature can be appropriately set depending on the use of the organic film, the kind of the base material, the kind of the compound (A) or the polymerization initiator in the composition, and the like. For example, in a case where the composition contains the basic monomer as the compound (A), the heating temperature is preferably set to equal to or higher than the 10-hour half-life temperature Oi of the thermal polymerization initiator. The heating temperature is more preferably θi+20° C. or higher and more preferably θi+40° C. or higher.

In the application and drying step, the temperature and the concentration are preferably controlled to prevent the temperature and the concentration from deviating from a temperature range and a concentration range within which the composition exhibits lyotropic liquid crystallinity. In the application and drying step, when a temperature or concentration at which the composition is fluid but does not exhibit lyotropic liquid crystallinity is reached, there is a likelihood that the alignment may loosen and the anisotropy of the coating may disappear.

At the time of producing the organic film, when a treatment of heating or exposing the composition is performed, the acidic functional group in the polymer (P) and the basic functional group in the compound (A) interact each other as an acid and a base, and the polymer (P) is ionically cross-linked and becomes insoluble. Therefore, it is possible to obtain an organic film that has high water resistance or dynamic properties and has excellent optical and electrical properties.

Here, in order to ionically cross-link a polyanion and a polycation, ordinarily, a treatment of immersing the organic film in a multivalent metal ion aqueous solution (for example, a calcium hydroxide aqueous solution or the like) or the like (passivation treatment) becomes necessary. In contrast, according to the above-described composition, it is possible to form an ionic cross-link in the film by performing heating or exposure during the formation of the film. Therefore, a step of performing the passivation treatment may not be provided after the formation of the film, and it is possible to simplify production steps, which is preferable.

The aspect of ionic cross-linking by heating or exposure varies with the kind of the compound (A). In a case where the compound (A) is the basic monomer, the basic monomer is polymerized by heat or light to turn into a polycation, and the polycation interacts with a polyanion derived from the polymer (P) as an acid and a base to form a polyion complex in the film. At this time, in a case where the present composition contains a thermal polymerization initiator, it is possible to form an ionic cross-link in the film by heating performed for the formation of the film. Therefore, a step for ionic cross-linking may not be separately provided after the formation of the film, and it is possible to further simplify the production steps.

In a case where the compound (A) is the base-generating agent, a base is generated by heat or light and interacts with the polyanion derived from the polymer (P) as a base and an acid to form an ionic cross-link in the film. Particularly, in the case of containing a multifunctional thermal base-generating agent as the compound (A), a polycation is generated by heating during the formation of the film, and the polycation interacts with the polyanion derived from the polymer (P) as an acid and a base, whereby it is possible to form a polyion complex in the film. Therefore, a passivation step may not be separately provided after the formation of the film.

In a case where the compound (A) is a photopolymerizable monomer or a photobase-generating agent, a coating fluid may be exposed before being dried or may be exposed after the organic film is formed by drying the coating fluid. In the latter method, it is possible to form a pattern on the organic film by exposing the organic film through a photomask. That is, an exposed portion in the exposed organic film becomes insoluble to water-based solvents due to the formation of an ionic cross-link; on the other hand, a non-exposed portion remains soluble to water-based solvent. Therefore, it is possible to obtain an organic film having a desired pattern by using a water-based solvent as a developer and bringing the exposed organic film into contact with the developer.

The polymer (P) is a rigid rod-like macromolecule and acts as a mesogen in solvents. Particularly, since the polymer (PI) is a rigid aromatic polyimide that has a structure in which a benzene ring and an imide ring are linked together or a structure in which a naphthalene ring and an imide ring are linked together in the main chain and is highly monoaxially linear, the polymer (PI) is likely to be aligned in a plane in a thin film interface by being stacked between molecules and is capable of forming liquid crystal alignment films having an excellent polar anchoring energy. In addition, it is possible to align rod-like molecules or the like along the molecular chains of the polymer (P) by introducing the rod-like molecules or the like (guest) into a lyotropic liquid crystal field (host) that is generated by the polymer (P). Therefore, the use of the composition of the present disclosure enables phase difference plates, polarization plates, wavelength conversion plates, and the like exhibiting favorable properties to be simply formed using the properties of the polymer (P) while reducing environmental burdens.

<<Liquid Crystal Alignment Film and Liquid Crystal Element>>

A liquid crystal alignment film of the present disclosure can be formed using the composition prepared as described above as a liquid crystal aligning agent. In addition, a liquid crystal element of the present disclosure includes the liquid crystal alignment film formed using the composition (liquid crystal aligning agent). The composition of the present disclosure is capable of imparting a liquid crystal aligning capability to coatings by a shear flow. Therefore, according to the above-described composition, at the time of forming the liquid crystal alignment film, a rubbing treatment or a photo-alignment treatment of the related art is not necessary, and it is possible to simplify steps. In addition, the composition is a water-based solvent and thus can be fired at low temperatures, which brings another merit that environmental burden can be reduced. In the case of manufacturing a liquid crystal display element, the drive mode of the liquid crystal display element is not particularly limited, and a variety of drive modes such as a TN type, a STN type, an IPS type, an FFS type, a VA type, an MVA type, and a PSA type are applicable.

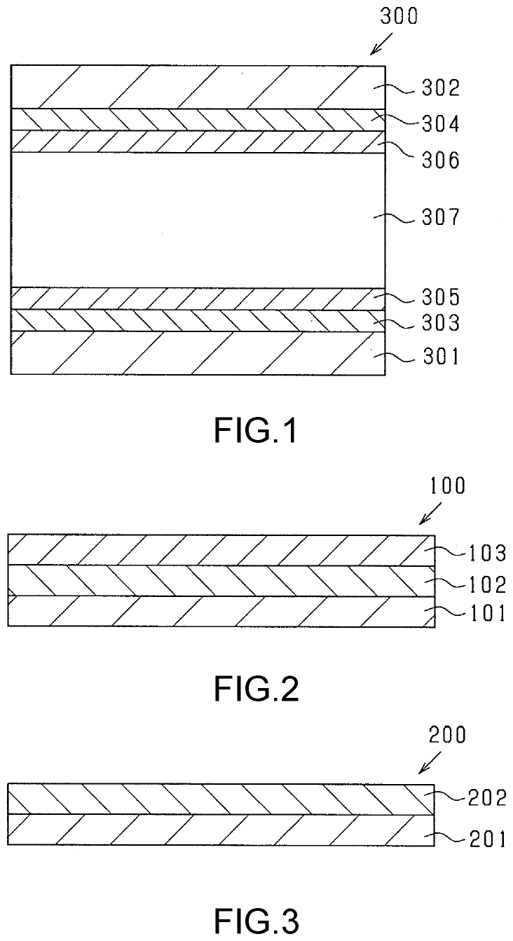

FIG. 1 shows a schematic configuration view of a TN-type liquid crystal display device 300 as a specific example of the liquid crystal element. The liquid crystal display device 300 of FIG. 1 includes a pair of substrates 301 and 302, a pair of electrodes 303 and 304 formed on the substrate surfaces of the pair of substrates 301 and 302, respectively, and liquid crystal alignment films 305 and 306 formed on the electrode surfaces of the pair of electrodes 303 and 304, respectively. The pair of substrates 301 and 302 are disposed opposite to each other across a predetermined cell gap such that the liquid crystal alignment films 305 and 306 face each other. A liquid crystal layer 307 is provided adjacent to the liquid crystal alignment films 305 and 306 between the pair of substrates 301 and 302. Polarization plates (not shown) are attached to the outer surfaces of the substrates 301 and 302. In the liquid crystal display device 300, the alignment of liquid crystals in the liquid crystal layer 307 is controlled by applying a voltage as necessary between the pair of substrates 301 and 302.

The liquid crystal display element can be manufactured by, for example, a method including a step (1-1) and a step (1-2) described below.

[Step (1-1): Application and Drying]

First, the composition is applied onto a substrate, and then, preferably, the coated surface is heated, thereby forming a coating on the substrate. As the substrate, it is possible to use, for example, glass such as float glass or soda glass; a transparent substrate made of plastic such as polyethylene terephthalate, polybutylene terephthalate, polyether sulfone, polycarbonate, or poly(alicyclic olefin). As a transparent conductive film that is provided on one surface of the substrate, it is possible to use, for example, a NESA film made of tin oxide (SnO₂) (registered trademark of PPG Industries, Inc.), an ITO film made of indium-tin oxide (In₂O₃—SnO₂), or the like. In the case of manufacturing a TN-type, STN-type, or VA-type liquid crystal element, two substrates provided with a patterned transparent conductive film are used. Meanwhile, in the case of manufacturing an IPS type or FFS-type liquid crystal element, a substrate provided with an electrode made of a transparent conductive film or metal film patterned in a comb teeth form and an opposite substrate provided with no electrode are used. As the metal film, it is possible to use, for example, a film made of metal such as chromium. The liquid crystal aligning agent is preferably applied to the electrode-formed surfaces of the substrates, respectively, by a bar coater method, an applicator method, a die coater method, or a blade coater method.

In the application of the liquid crystal aligning agent, the relative speed of a coater with respect to the substrate (hereinafter, referred to as “shear speed”) is preferably 1 to 200 cm/s, more preferably 2 to 100 cm/s, and particularly preferably 5 to 50 cm/s from the viewpoint of controlling the liquid crystal pretilt angle of the liquid crystal alignment film interface in the liquid crystal element. It should be noted that the liquid crystal pretilt angle depends on the molecular alignment in a coating interface and varies due to a variety of factors such as the coater shape or drying conditions in addition to the shear speed, and thus it is possible to appropriately set the respective factors depending on the liquid crystal aligning agent.

After the application of the composition, preliminary heating (prebaking) is preferably performed for the purpose of preventing the dripping of the applied composition. The prebaking temperature is preferably 30° C. to 100° C., more preferably 40° C. to 80° C., and particularly preferably 40° C. to 60° C. The prebaking time is preferably 0.25 to 10 minutes and more preferably 0.5 to 5 minutes. After that, firing (post baking) is performed according to the purpose of completely removing the solvent or the like. The firing temperature at this time (post baking temperature) is preferably 60° C. to 300° C. and more preferably 100° C. to 250° C. The post baking time is preferably 5 to 120 minutes and more preferably 10 to 60 minutes. In the heating step, it is preferable to put the coating made from the liquid crystal aligning agent applied onto the base material into a state in which the molecular chains of the polymer (P) are aligned by a flow induced by shear stress and dry the coating in this state. In such a case, a liquid crystal aligning capability is imparted to the coating by a simple operation, which enables the formation of a liquid crystal alignment film. The film thickness of the film to be formed is preferably 1 nm to 1 μm and more preferably 5 nm to 0.5 μm.

[Step (1-2): Construction of Liquid Crystal Cell]

In the present step, two substrates on which the liquid crystal alignment film is formed are prepared, and liquid crystals are disposed between the two substrates disposed opposite to each other, thereby manufacturing a liquid crystal cell. For the manufacturing of the liquid crystal cell, the following two methods are exemplary examples. In a first method, first, two substrates are disposed opposite to each other across a space (cell gap) such that the respective liquid crystal alignment films become opposite to each other, the peripheral portions of the two substrates are attached to each other using a sealing agent, the inside of the cell gap compartmented by the surfaces of the substrates and the sealing agent is filled by pouring liquid crystals into the cell gap, and then the pouring hole is sealed, thereby manufacturing a liquid crystal cell. In a second method (ODF method), for example, an ultraviolet-curable sealing agent is applied to a predetermined place on one substrate out of two substrates on which the liquid crystal alignment film is formed, furthermore, liquid crystals are added dropwise to several predetermined places on the surface of the liquid crystal alignment film, then, the other substrate is attached such that the liquid crystal alignment films become opposite to each other, the liquid crystals are pressed to spread throughout the entire surfaces of the substrates, and then the entire surfaces of the substrates are irradiated with ultraviolet light to cure the sealing agent, thereby manufacturing a liquid crystal cell. In any case where a liquid crystal cell is manufactured by any method, the liquid crystal cell manufactured as described above is desirably further heated up to a temperature at which the liquid crystals used become an isotropic phase and are then slowly cooled to room temperature, thereby removing a flow orientation formed at the time of filling the space with the liquid crystals.

As the sealing agent, it is possible to use, for example, a curing agent, an epoxy resin containing an aluminum oxide sphere as a spacer, or the like. Examples of the liquid crystals include nematic liquid crystals and smectic liquid crystals, and, between these, nematic liquid crystals are preferred. In addition, a liquid crystal display element can be obtained by attaching polarization plates to the outer surfaces of the liquid crystal cell. Examples of the polarization plate include a polarization plate in which a polarization film that is referred to as “H film” is sandwiched by cellulose acetate protective films or a polarization plate made of the H film. In the H film, iodine is absorbed while polyvinyl alcohol is aligned by stretching.

The liquid crystal element of the present disclosure can be effectively applied to a variety of uses and can be applied to, for example, a variety of liquid crystal display devices such as watches, handheld game consoles, word processors, laptop computers, car navigation systems, camcorders, PDAs, digital cameras, mobile phones, smartphones, a variety of monitors, liquid crystal televisions, and information displays, dimming films, and the like.

<<Phase Difference Plate>>

A phase difference plate of the present disclosure can be manufactured using the above-described composition. Specific examples of the phase difference plate include a phase difference plate 100 shown in FIG. 2. The phase difference plate 100 has a base material 101, a liquid crystal alignment film 102, and a liquid crystal layer 103 and is formed by laminating these members in this order. The phase difference plate 100 can be manufactured by, for example, a method including a step (2-1) and a step (2-2) described below.

[Step (2-1): Application and Drying]

In order to manufacture the phase difference plate of the present disclosure, the above-described composition is preferably applied onto the base material 101 (for example, a glass base material, triacetyl cellulose (TAC), polyethylene terephthalate, polymethyl methacrylate, or the like) by a bar coater method, an applicator method, a die coater method, or a blade coater method. Subsequently, the coating fluid on the base material 101 is dried in a state in which the molecular chains of the polymer (P) are aligned by a flow induced by shear stress.

A drying treatment is preferably performed by heating (baking) the coated surface. At this time, preliminary heating (prebaking) may be performed for the purpose of preventing dripping, and then post baking may be performed. The heating temperature is preferably set to 40° C. to 150° C. and more preferably set to 80° C. to 140° C. The heating time is preferably 0.1 to 120 minutes and more preferably 1 to 60 minutes. The film thickness of a coating (liquid crystal alignment film 102) to be formed on the base material is preferably 1 nm to 1 μm and more preferably 5 nm to 0.5 μm.

[Step (2-2): Formation of Liquid Crystal Layer]

Next, polymerizable liquid crystals are applied onto the liquid crystal alignment film 102 formed as described above and cured. Therefore, a layer including the polymerizable liquid crystals (liquid crystal layer 103) is formed. The polymerizable liquid crystals that are used here is a liquid crystal compound or liquid crystal composition that is polymerized by at least one treatment of heating and light irradiation. As such polymerizable liquid crystals, it is possible to use well-known liquid crystals of the related art that are used to form liquid crystal layers in phase difference plates, and examples thereof include nematic liquid crystals having a polymerizable group out of liquid crystals described in “Liquid crystal handbook” (edited by the editorial committee of liquid crystal handbook). At the time of forming a liquid crystal phase, a mixture of a plurality of liquid crystal compounds may be used as the polymerizable liquid crystals and a composition containing a well-known polymerization initiator, an appropriate solvent, or the like may be used. In order to apply the polymerizable liquid crystals onto the formed liquid crystal alignment film, it is possible to adopt an appropriate application method such as a bar coater method, a roll coater method, a spinner method, a printing method, or an inkjet method.

Next, one or more treatments selected from heating and light irradiation are performed on the polymerizable liquid crystals applied onto the liquid crystal alignment film 102, thereby curing the coating to form the liquid crystal layer 103. These treatments are preferably performed multiple times since favorable alignment can be obtained. The heating temperature at this time is appropriately selected depending on the kind of the polymerizable liquid crystals that are used. In the case of using, for example, RMS03-013C manufactured by MERCK KGAA, the polymerizable liquid crystals are preferably heated within a temperature range of 40° C. to 80° C. The heating time is preferably 0.5 to 5 minutes. In addition, as irradiation light, it is possible to preferably use unpolarized ultraviolet light having wavelengths within a range of 200 to 500 nm. The amount of light irradiation is preferably 50 to 10,000 mJ/cm² and more preferably 100 to 5,000 mJ/cm².

The thickness of the liquid crystal layer 103 that is to be formed is appropriately set depending on desired optical properties. For example, in the case of manufacturing a ½ wave plate for visible light having a wavelength of 540 nm, the thickness is selected such that the phase difference of a formed phase difference film becomes 240 to 300 nm, and, in the case of a ¼ wave plate, the thickness is selected such that the phase difference becomes 120 to 150 nm. The thickness of the liquid crystal layer 103 from which a target phase difference can be obtained varies with the optical properties of the polymerization liquid crystals that are used. In the case of using, for example, RMS03-013C manufactured by MERCK KGAA, the thickness for manufacturing a ¼ wave plate is within a range of 0.6 to 1.5 μm.

The phase difference plate obtained by the above-described method is preferred as a phase difference plate for liquid crystal display elements. The operation mode of a liquid crystal display element to which the phase difference plate is applied is not limited, and the phase difference plate can be applied to a variety of well-known modes such as a TN type, a STN type, an IPS type, an FFS type, and a VA type. The phase difference plate 100 is used in a state in which the base material-side surface of the phase difference plate is attached to the outer surface of a polarization plate disposed on the viewer side of a liquid crystal display element. Therefore, it is preferable to use a TAC or acrylic base material as the base material of the phase difference plate and to make the base material of the phase difference plate function as a protective film for a polarization film.

Here, as a method for producing the phase difference plate in an industrial scale, there is a roll-to-roll method. In this method, a step of continuously performing a treatment of unwinding a long base material film from a roll of the film and forming the liquid crystal alignment film 102 on the unwound film, a treatment of applying and curing the polymerizable liquid crystals on the liquid crystal alignment film 102, and a treatment of laminating a protective film as necessary is performed and then the film that has undergone the step is collected as a roll. The above-described composition that is used for the formation of the liquid crystal alignment film 102 is preferable since the composition is capable of simplifying a step for aligning the molecular chains by shear stress at the time of applying the composition and of manufacturing the phase difference plate 100 at low costs. In addition, when the liquid crystal alignment film 102 is formed using the composition, the alignment of the liquid crystal alignment film 102 does not easily loosen even in a case where the polymerizable liquid crystals are applied onto the liquid crystal alignment film 102, and it is possible to develop an excellent optical compensation function.

<<Polarization Plate>>

A polarization plate of the present disclosure can be manufactured using the above-described composition. Specific examples of the polarization plate include a polarization plate 200 shown in FIG. 3. The polarization plate 200 has a base material 201 and a polarization film 202 and is formed by laminating these members in this order.

In order to produce, for example, a guest-host polarization plate, first, a composition containing the polymer (P), water, the compound (A), and a dichroic pigment is preferably applied onto a base material (for example, a glass base material, triacetyl cellulose (TAC), polyethylene terephthalate, polymethyl methacrylate, or the like) by a bar coater method, an applicator method, a die coater method, or a blade coater method. Next, the composition is dried in a state in which the molecular chains of the polymer (P) are aligned by a flow induced by shear stress. Therefore, a guest-host polarization plate can be obtained. In addition, a resin film (protective film) may be attached to one surface or both surfaces of the polarization plate as necessary. At this time, a protective film having an optical function such as a phase difference film may be used as the protective film. Regarding the conditions at the time of applying and drying the composition, the description for the phase difference plate is applied. The film thickness of the polarization film to be formed on the base material is preferably 0.1 to 50 μm and more preferably 1 to 10 μm.

As the dichroic pigment, it is possible to use iodine or a dichroic organic dye. The dichroic dye that is used is not particularly limited, a well-known compound can be used, and examples thereof include a polyiodide, an azo compound, an anthraquinone compound, a dioxazine compound, or the like. One kind of dichroic pigment may be used singly or two or more kinds of dichroic pigments may be used in combination. The proportion of the dichroic pigment blended (the total amount in a case where two or more kinds of dichroic pigments are blended) is preferably 0.05% to 15% by mass and more preferably 0.10% to 10% by mass with respect to the total mass in the composition.

In order to produce a reflective polarization plate, a composition containing the polymer (P), water, the compound (A), and metal (metal nanorod, metal nanowire, or metal ion) is used, and the composition is applied onto a base material in the same manner as in the method for producing the guest-host polarization plate. Next, the composition is dried in a state in which the molecular chains of the polymer (P) are aligned by a flow induced by shear stress. Therefore, a reflective polarization plate can be obtained. In the case of using a metal ion as the metal, a treatment of anisotropically precipitating pure metal along the polymer (P) by reduction is performed, whereby it is possible to obtain a polarization plate having excellent optical anisotropy.

The polarization plate obtained as described above has favorable polarization properties and thus can be preferably used as a polarization plate that is attached to a variety of display devices such as a liquid crystal display device and an organic electroluminescence (EL) display device.

<<Liquid Crystal Antenna>>

A liquid crystal antenna of the present disclosure includes a liquid crystal alignment film produced using the above-described composition. Hereinafter, an embodiment of the liquid crystal antenna will be described with reference to the drawings.

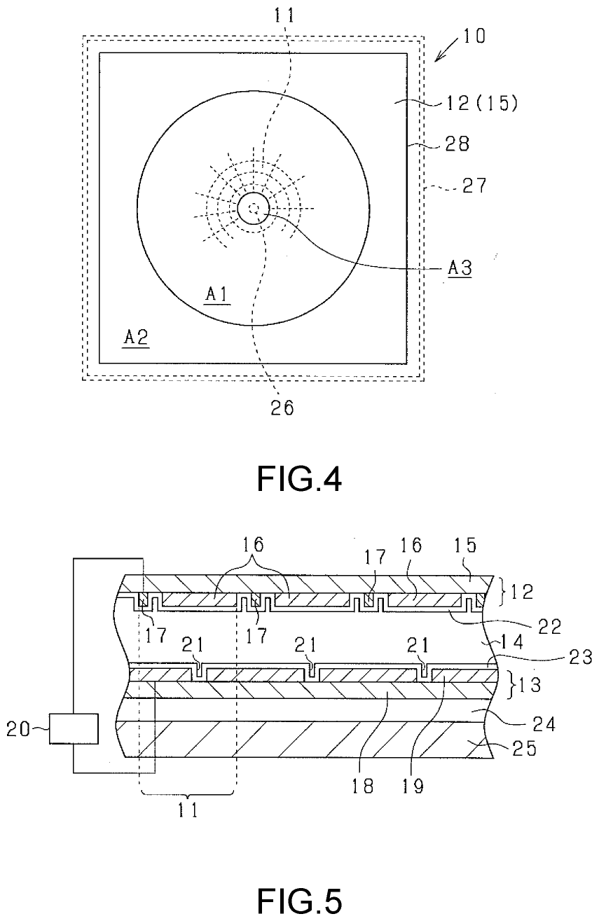

FIG. 4 and FIG. 5 show an example of a liquid crystal antenna 10. The liquid crystal antenna 10 is a planar liquid crystal antenna in which the permittivity of a liquid crystal material changing depending on the intensity of an electric field is used and is a phased array antenna having a plurality of antenna units 11. The liquid crystal antenna 10 sends high-frequency energy as an electromagnetic wave in an arbitrary direction of a space or receives an electromagnetic wave in an arbitrary direction of the space by changing the permittivity of the liquid crystal material in each antenna unit 11 by controlling an electric field that is applied to the liquid crystal material.

The liquid crystal antenna 10 is a radial line slot antenna in which the plurality of antenna units 11 is concentrically disposed with a wave sending and receiving region A1 that functions as a wave sending and receiving portion and is capable of sending or receiving circularly polarized waves. The liquid crystal antenna 10 includes a patch substrate 12, a slot substrate 13, and a liquid crystal layer 14 as shown in FIG. 5. In the liquid crystal antenna 10, the wave sending and receiving region A1 has an annular shape, a non-wave sending and receiving region A2 is disposed on the outer circumferential side of the wave sending and receiving region A1, and a non-wave sending and receiving region A3 is disposed on the inner circumferential side of the wave sending and receiving region A1.

The patch substrate 12 has a dielectric substrate 15 such as a glass substrate or a plastic substrate, a plurality of patch electrodes 16 formed on one surface of the dielectric substrate 15, and a plurality of TFT's 17 connected to the plurality of patch electrodes 16, respectively. The patch electrode 16 is a metal layer made of copper, aluminum, or the like and has a thickness of, for example, approximately 1 to 2 μm. The TFT 17 is electrically connected to a gate bus line and a source bus line (not shown), respectively, and electric conduction is controlled with a control unit 20. Each antenna unit 11 is configured to include one patch electrode 16 and one TFT 17. Each region of the antenna unit 11 is designated by the gate bus line and the source bus line.

The slot substrate 13 has a dielectric substrate 18 such as a glass substrate or a plastic substrate and a slot electrode 19 in which a plurality of slots 21 is disposed. The slot electrode 19 is a metal layer made of copper, aluminum, or the like and has a thickness of, for example, approximately 2 to 20 μm. Electric conduction to the slot electrode 19 is controlled with the control unit 20. On the slot electrode 19, the plurality of slots 21 is formed of a pair of slots that extend in mutually intersecting directions and are concentrically disposed with the wave sending and receiving region A1.

A first alignment film 22 is formed on the electrode-formed surface of the patch substrate 12, and a second alignment film 23 is formed on the electrode-formed surface of the slot substrate 13. The first alignment film 22 and the second alignment film 23 are liquid crystal alignment films that regulate the alignment of liquid crystal molecules. These alignment films 22 and 23 are formed by applying the above-described composition onto the substrates and drying the composition in a state in which the molecular chains of the polymer (P) are aligned by a flow induced by shear stress.

The patch substrate 12 and the slot substrate 13 are disposed at a predetermined interval through a sealing agent disposed in the non-wave sending and receiving regions A2 and A3 such that the electrode-formed surfaces (that is, the liquid crystal alignment film-formed surfaces) become opposite to each other. In each antenna unit 11, the patch electrode 16 is disposed opposite to the slot 21 (refer to FIG. 5). A liquid crystal layer 14 is provided adjacent to the first liquid crystal alignment film 22 and the second liquid crystal alignment film 23 in a space surrounded by the patch substrate 12, the slot substrate 13, and the sealing agent. The liquid crystal layer 14 is filled with a liquid crystal material.

As the liquid crystal material that forms the liquid crystal layer 14, a material that has a highly anisotropic permittivity with respect to high-frequency waves such as microwaves or millimeter waves and has a small dielectric loss (that is, tan δ) is preferred. Specifically, it is possible to use, for example, a bistolane-based compound (for example, a compound shown in Formula (R-1)), an oligophenylene-based compound (for example, a compound shown in Formula (R-2)), a mixture of the bistolane-based compound and the oligophenylene-based compound, or the like. The thickness of the liquid crystal layer 14 is, for example, 5 to 400 μm.

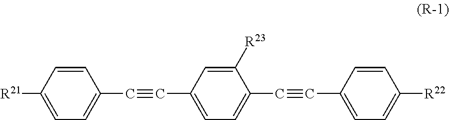

(In Formula (R-1), R²¹ to R²³ are each independently an alkyl group having 1 to 15 carbon atoms, an alkoxy group, an alkenyl group, an alkenyloxy group, an alkoxyalkyl group, a cycloalkyl group, an alkylcycloalkyl group, a cycloalkenyl group, an alkylcycloalkenyl group, an alkylcycloalkylalkyl group, or an alkylcycloalkoxyalkyl group.)

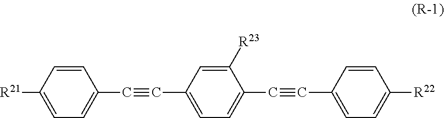

(In Formula (R-2), R²⁴ and R²⁵ are each independently a hydrogen atom, a halogen atom, an alkyl group having 1 to 15 carbon atoms, a fluorinated alkyl group, an alkoxy group, a fluorinated alkoxy group, an alkenyl group, a fluorinated alkenyl group, an alkenyloxy group, an alkoxyalkyl group, a fluorinated alkoxyalkyl group, a cycloalkyl group, an alkylcycloalkyl group, a cycloalkenyl group, an alkylcycloalkenyl group, an alkylcycloalkylalkyl group, or an alkylcycloalkenylalkyl group. R²⁶ is a fluorine atom, a chorine atom, or an alkyl group having 1 to 15 carbon atoms. k is an integer of 0 to 4, 5 and m is an integer of 6 to 25.).

As specific examples of the liquid crystal material, examples of the bistolane-based compound include compounds shown in Formula (r-1-1) to Formula (r-1-4), respectively, and the like; examples of the oligophenylene-based compound include compounds shown in Formula (r-2-1) and Formula (r-2-2), respectively, and the like. It should be noted that one kind of liquid crystal material can be used singly or two or more kinds of liquid crystal materials can be used in combination.

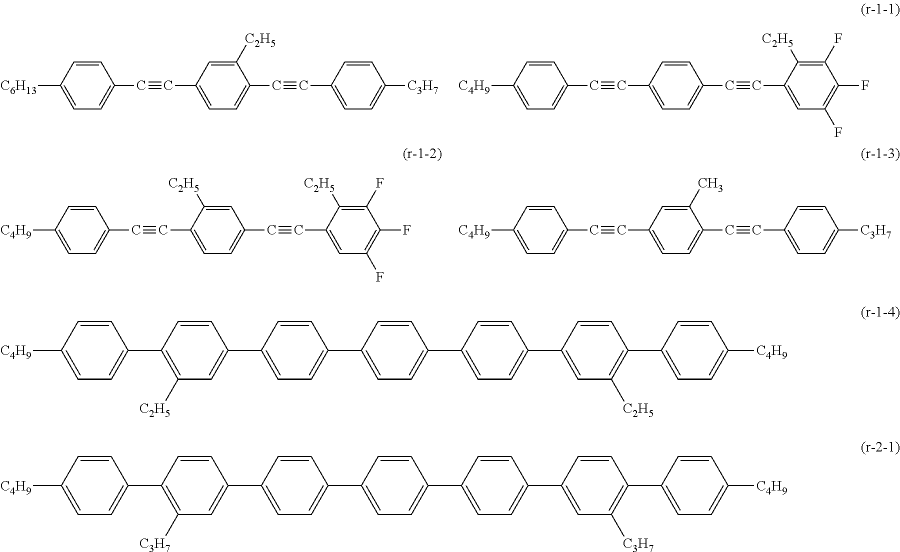

A grounding plate 25 is disposed through a low dielectric layer 24 on a side of the slot substrate 13 opposite to the electrode-formed surface. The grounding plate 25 is formed of an aluminum plate or a copper plate and has a thickness of approximately several millimeters. The low dielectric layer 24 is made of a layer having a low permittivity with respect to high-frequency waves and is an air layer in the present embodiment. It should be noted that, for example, a resin layer made of a fluororesin such as PTFE may be disposed as the low dielectric layer 24 instead of the air layer.

A feed pin 26 is attached to the non-wave sending and receiving region A3 on the side of the slot substrate 13 opposite to the electrode-formed surface. The feed pin 26 penetrates the grounding plate 25 and is connected to a signal line, not shown. The plurality of antenna units 11 is disposed alongside the wave sending and receiving region A1 concentrically around the feed pin 26 as the center. The liquid crystal antenna 10 receives an electromagnetic wave of a space from the patch substrate 12 side or radiates an electromagnetic wave to the space and also transmits high-frequency energy through the slot electrode 19, the dielectric substrate 18, the low dielectric layer 24, and the grounding plate 25 that function as waveguides.

In the liquid crystal antenna 10, an internal unit 28 including the patch substrate 12, the slot substrate 13, and the liquid crystal layer 14 is stored in a resin housing 27 (refer to FIG. 4). Since it is possible to decrease the dielectric loss of the liquid crystal antenna 10, the housing 27 is preferably a resin container formed using at least one selected from the group consisting of an epoxy resin, a polyimide resin, a liquid crystal polymer, and a fluororesin. In the present embodiment, the housing 27 is formed using a fluororesin (PTFE or the like). The size of the liquid crystal antenna 10 is appropriately set depending on the communication amount or the like and is, for example, 20 cm to 3 m.

In the liquid crystal antenna 10 obtained using the above-described composition, the film strength of the liquid crystal alignment film is high, the water resistance is excellent, and furthermore, the dielectric loss is small. Therefore, this liquid crystal antenna is preferably used for sending, receiving, or sending and receiving high-frequency waves such as microwaves or millimeter waves. The uses thereof are not particularly limited, and the liquid crystal antenna can be applied to antennas that are mounted in moving bodies, for example, automobiles, railway vehicles, aircrafts, ships, and robots and, specifically, to information communication antennas, broadcasting antennas, telephone antennas, GPS antennas, and the like.

<<Method for Manufacturing Patterned Liquid Crystal Alignment Film>>

In a case where the composition contains a photopolymerization initiator or a photobase-generating agent as a photosensitive compound, it is possible to impart a pattern to the liquid crystal alignment film by irradiating the liquid crystal alignment film formed using the composition with radioactive rays. A patterned liquid crystal alignment film of the present disclosure can be manufactured by, for example, a method including a step (3-1), a step (3-2), and a step (3-3) described below.

[Step (3-1): Application and Drying Step]

In the present step, a composition containing a photopolymerization initiator or a photobase-generating agent as the compound (A) is applied onto a substrate in a liquid crystal phase state and dried in a state in which the molecular chains of the polymer (P) are aligned by a flow induced by shear stress. Therefore, a photosensitive liquid crystal alignment film is formed on the substrate. Regarding the respective conditions for the application and the drying in the present step, the description of the step (1-1) is applied.

[Step (3-2): Exposure Step]

Subsequently, in the present step, the liquid crystal alignment film formed in the step (3-1) is irradiated with radioactive rays through a mask having a predetermined pattern. This irradiation with radioactive rays forms a polyion complex in the film to make an exposed portion insoluble to water-based solvents but leaves a non-exposed portion to remain water-soluble. The exposure conditions such as the exposure amount or the exposure time can be appropriately selected depending on the formulation of the composition, the kind of an additive, and the like.

[Step (3-3): Development Step]

Subsequently, the exposed liquid crystal alignment film is developed, whereby a liquid crystal alignment film having a desired pattern (patterned liquid crystal alignment film) can be obtained. As a developer that is used in the development step, it is possible to use not only water but also a different solvent that may be blended into the present composition or a solvent mixture of water and the different solvent. The development conditions such as the amount of the developer used or the development time can be appropriately selected depending on the formulation of the lyotropic liquid crystal composition, the kind of the additive, and the like.

The patterned liquid crystal alignment film that is obtained as described above can be used for a variety of optical uses. For example, in the liquid crystal alignment film formed on the substrate, the outer edge portion coated with a sealing material is not exposed, and regions other than the outer edge portion are exposed and developed, thereby removing the liquid crystal alignment film in the outer edge portion. Therefore, it is possible to bring the substrate and the sealing material into direct contact and to improve the adhesion between the substrate and the sealing material. Alternately, it is also possible to form a liquid crystal alignment film that is used for optical uses such as holography by patterning the liquid crystal alignment film.

### EXAMPLES

Hereinafter, the present disclosure will be more specifically described using examples, but the present disclosure is not limited these examples.

The structures and abbreviations of main compounds used in the following examples are as described below.

(Tetracarboxylic dianhydrides)

TA-1: Pyromellitic dianhydride

TA-2: 1,4,5,8-Naphthalenetetracarboxylic dianhydride

TA-3: 2,3,4,7-Naphthalenetetracarboxylic dianhydride

TA-4: 4,4′-Biphthalic dianhydride

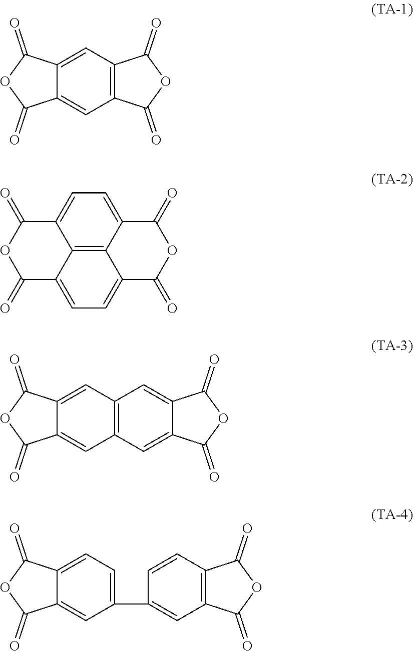 [SMILES: O=c1oc(=O)c2cc3c(=O)oc(=O)c3cc12 ; O=C1OC(=O)c2ccc3c4c(ccc1c24)C(=O)OC3=O ; O=c1oc(=O)c2cc3cc4c(=O)oc(=O)c4cc3cc12 ; O=C1OC(=O)c2cc(-c3ccc4c(c3)C(=O)OC4=O)ccc21]

(Diamines)

DA-1: 2,5-Diaminobenzenesulfonic acid

DA-2: 4,4′-Diamino-2,2′-biphenyldisulfonic acid

DA-3: 4,4′-Diaminostilbene-2,2′-disulfonic acid

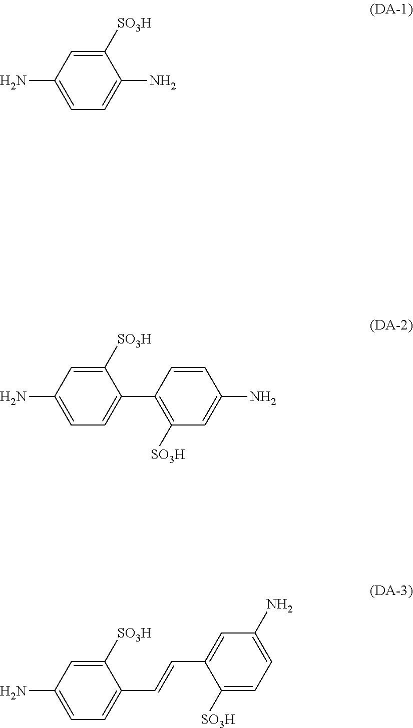 [SMILES: Nc1ccc(N)c(S(=O)(=O)O)c1 ; Nc1ccc(-c2ccc(N)cc2S(=O)(=O)O)c(S(=O)(=O)O)c1 ; Nc1ccc(S(=O)(=O)O)c(/C=C/c2ccc(N)cc2S(=O)(=O)O)c1]

(Basic Monomer)

M-1: N,N-Dimethylaminopropylacrylamide

(Polymerization Initiators)

I-1: 2,2′-Azobis[2-(2-imidazolin-2-yl)propane] disulfate dihydrate

I-2: 2-Hydroxy-4′-(2-hydroxyethoxy)-2-methylpropiophenone

(Thermal Base-Generating Agents)

A-1: N-α-(tert-Butoxycarbonyl)-L-arginine

A-2: Triethylenediamine oxalate

### Synthesis Example 1

(1) Synthesis of Polymer

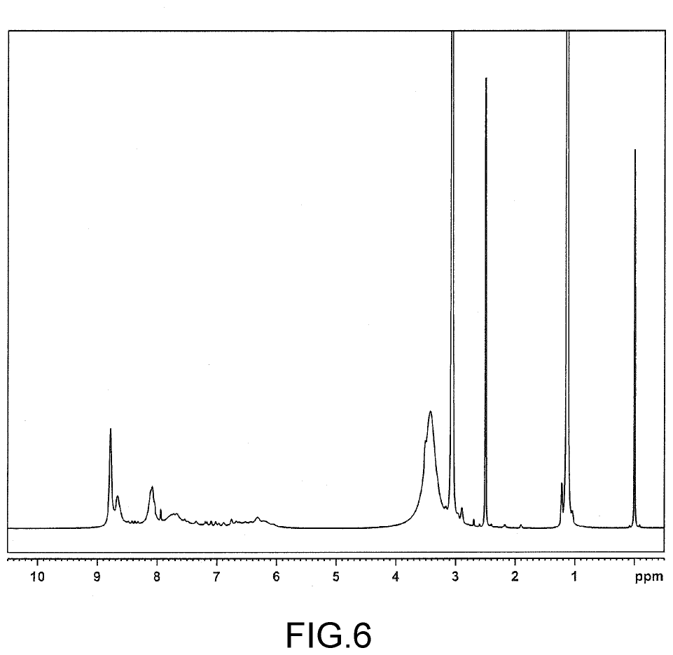

The diamine (DA-1) (1.88 g, 10.0 mmol), m-cresol (30 mL), and triethylamine (2.43 g, 24.0 mmol) were put into a three-neck flask including a reflux tube, a thermometer, and a nitrogen introduction tube and stirred under nitrogen at 80° C. After the dissolution of the diamine, the acid dianhydride (TA-1) (2.09 g, 9.6 mmol) and benzoic acid (1.71 g, 14.0 mmol) were added thereto, stirred at 80° C. for three hours, and then stirred at 180C.° for 12 hours. A polymer was slowly precipitated with an imide ring-closing reaction, and a reaction mixture changed from a black-yellow solution to a red-orange slurry. After the end of the reaction, the reaction mixture was cooled in the air and poured into acetone to be solidified. The obtained solidified substance was filtered, stirred and cleansed in acetone, then, stirred and cleaned in isopropanol, and then dried in a vacuum at 120° C., thereby obtaining a polymer (4.06 g, yield: 72%, red-orange powder) in which a repeating unit that configured the polymer had a structure shown in Formula (PI-1). FIG. 6 shows the measurement result of a ¹H-NMR spectrum (DMSO-d⁶, 700 MHz) of the polymer (PI-1).

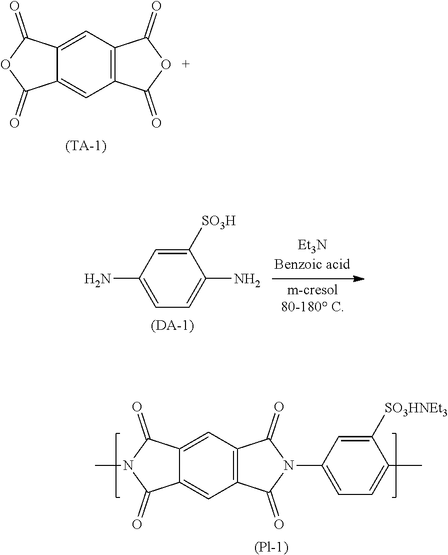

(2) Measurement of Imidization Rate

The polymer was dissolved in deuterated dimethylsulfoxide, and ¹H-NMR was measured at room temperature using tetramethylsilane as a reference substance. The imidization rate [%] of the polymer was obtained from the obtained ¹H-NMR spectrum using Expression (a).

Imidization rate [%]=(1−A_{NH}/A_{ArH}×α)×100 (a)

(In Expression (a), A_{NH} is the area of a peak derived from a proton of an amide group that appears at near 10 ppm, A_{ArH} is the area of a peak derived from an aromatic proton that appears within a range of 7 to 9 ppm, and a is the proportion of the number of aromatic protons in one proton of the amide group in polyamic acid, which is a precursor of the polymer.) As a result, the imidization rate of the polymer (PI-1) was 99% or more.

(3) Evaluation of Solubility

Water was added to the polymer (PI-1) obtained in the section (1) and heated and stirred at 60° C., thereby obtaining an aqueous solution of the polymer (PI-1). The solubility was evaluated as “favorable” in a case where it was possible to prepare an aqueous solution in which the solid solution concentration of the polymer reached 10% by mass or higher and evaluated as “poor” in a case where it was not possible to prepare an aqueous solution in which the solid solution concentration reached 1% by mass or higher. As a result, in this example, the solubility was evaluated as “favorable”.

(4) Evaluation of Liquid Crystallinity

The aqueous solution of the polymer (PI-1) obtained in the section (3) was added dropwise onto a glass substrate and observed with a polarization microscope, thereby evaluating the liquid crystallinity. With a solid solution concentration of the polymer within a concentration range of 1% to 10% by mass and a temperature of the aqueous solution in a temperature range of 20° C. or higher and lower than 80° C., in a case where optical anisotropy was observed under crossed Nicols in at least a part of the temperature range, the liquid crystallinity was evaluated as “favorable”, and, in a case where optical anisotropy was not observed in the above-described temperature range, the liquid crystallinity was evaluated as “poor”. Here, in a case where the polymer did not fully dissolve or the aqueous solution was not fluid (in a gel state, in a state with a significantly high viscosity, or the like), since it was not possible to evaluate the liquid crystallinity, “-” is expressed in Table 1. As a result, in this example, the solid solution concentration of the polymer was within a concentration range of 1% to 5% by mass, the temperature of the aqueous solution was within a temperature range of 20° C. to 80° C., and optical anisotropy was observed, and thus the liquid crystallinity was evaluated as “favorable”. It should be noted that, within a solid solution concentration of the polymer of 3% to 5% by mass, the liquid crystals were fluid in at least a partial region of a temperature range of the aqueous solution of 50° C. to 80° C., however, when the liquid crystals were cooled to room temperature, sol-gel transition occurred, and the liquid crystals turned into a non-fluid gel.

### Synthesis Examples 2 to 7

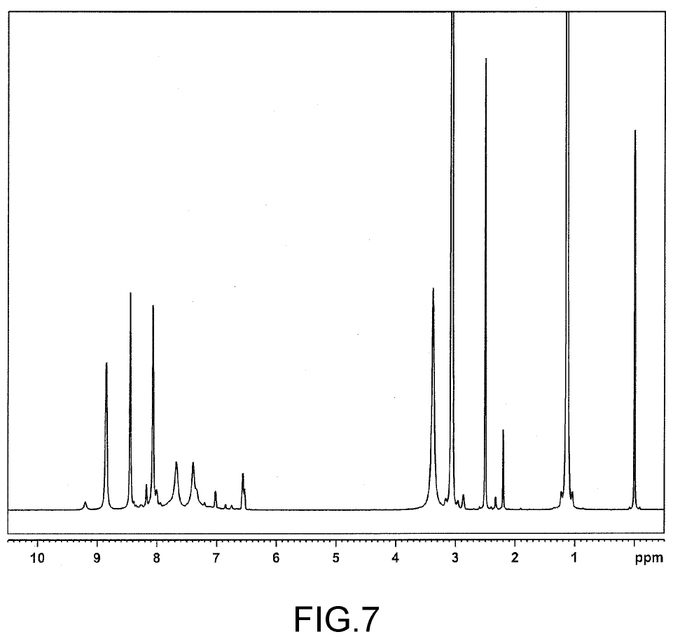

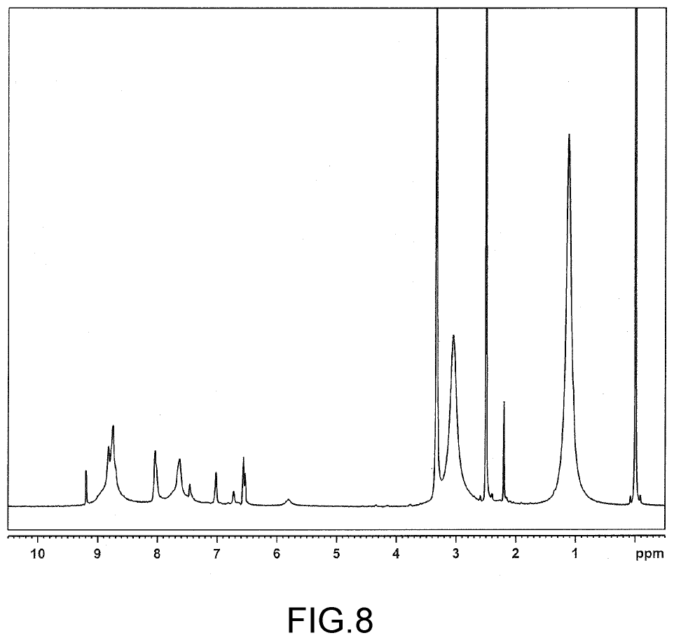

Polymers (PI-2 to PI-7) were synthesized, respectively, in the same manner as in Example 1 except that, in Synthesis Example 1, the kinds of the acid dianhydride and the diamine were changed as shown in Table 1, respectively. In addition, solubility and liquid crystallinity were evaluated using the obtained polymers (PI-2 to PI-7). The evaluation results are shown in Table 1. FIG. 7 and FIG. 8 show the measurement results of ¹H-NMR spectra (DMSO-d⁶, 700 MHz) of the polymers (PI-2) and (PI-4), respectively.

TABLE 1

| | | Acid | | | Liquid crystallinity | | | |
|---|---|---|---|---|---|---|---|---|
| | Polymer | dianhydride | Diamine | Solubility | 1 wt % | 3 wt % | 6 wt % | 10 wt % |
| Synthesis Example 1 | (PI-1) | (TA-1) | (DA-1) | Favorable | Favorable | Favorable | — | — |
| Synthesis Example 2 | (PI-2) | (TA-1) | (DA-2) | Favorable | Poor | Poor | Favorable | Favorable |
| Synthesis Example 3 | (PI-3) | (TA-1) | (DA-3) | Favorable | Poor | Poor | Poor | Poor |
| Synthesis Example 4 | (PI-4) | (TA-2) | (DA-1) | Favorable | Favorable | — | — | — |
| Synthesis Example 5 | (PI-5) | (TA-2) | (DA-2) | Favorable | Poor | Poor | Poor | Favorable |
| Synthesis Example 6 | (PI-6) | (TA-3) | (DA-1) | Poor | — | — | — | — |
| Synthesis Example 7 | (PI-7) | (TA-4) | (DA-1) | Favorable | Poor | Poor | Poor | Poor |

### Example 1

(1) Preparation of Composition

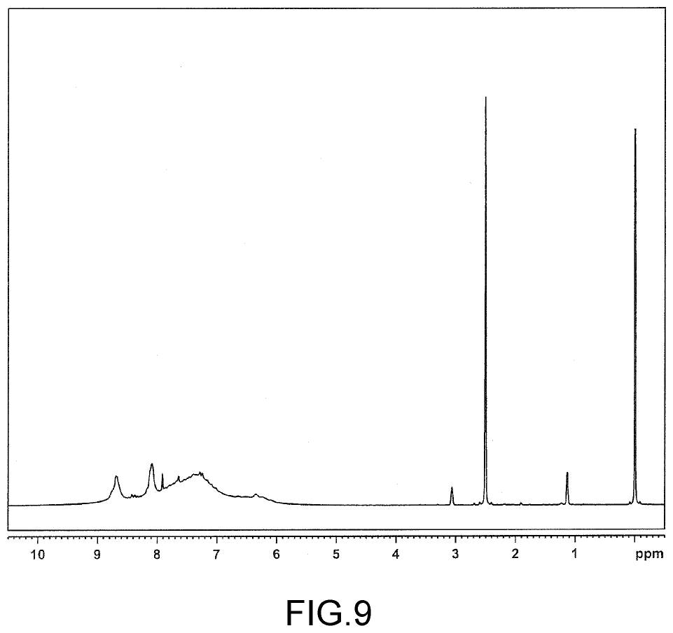

The polymer (PI-1) obtained in Synthesis Example 1 was dissolved in water and ion-exchanged through a strongly acidic cation exchange resin, thereby obtaining an aqueous solution of an acidic polymer in which the counter cation was exchanged from Et₃NH⁺ to H⁺ (hereinafter, referred to as “acidic polymer (PI-1A)”). The obtained aqueous solution was dialyzed against distilled water at room temperature using a regenerated cellulose dialysis tube (cut-off molecular weight: 3500, manufactured by Spectra/Por) and thereby further purified. The dialyzed aqueous solution was condensed under reduced pressure, 1 mole equivalent of the basic monomer (M-1) with respect to the acidic functional group of the acidic polymer (PI-1A) was added to the aqueous solution, and then the polymerization initiator (I-1) was added to and dissolved in the aqueous solution. The obtained aqueous solution was filtered with a filter having a pore diameter of 0.45 μm, thereby preparing a composition (C-1) in which the total solid solution concentration of the acidic polymer (PI-1A) and the basic monomer was 3% by mass and the solid solution concentration of the polymerization initiator was 0.05% by mass. FIG. 9 shows the measurement result of a ¹H-NMR spectrum (DMSO-d⁶, 700 MHz) of the acidic polymer (PI-1A).

(2) Formation of Liquid Crystal Alignment Film

The composition (C-1) prepared in the section (1) was heated to 50° C. and then applied to an electrode-formed surface of a transparent substrate including a transparent electrode using a bar coater at a shear speed of 10 cm/s. Next, this substrate was dried with a hot air (50° C.) for five minutes and then heated for 30 minutes in an oven (100° C.) the inside of which was substituted with nitrogen. Therefore, a liquid crystal alignment film having an average film thickness of 0.1 μm was formed on the substrate. This operation was repeated, thereby obtaining a pair of substrates each having the liquid crystal alignment film on the transparent electrode.

(3) Manufacturing of TN-Type Liquid Crystal Display Element

An epoxy resin adhesive containing aluminum oxide spheres having a diameter of 5.5 μm was applied to the liquid crystal alignment film-formed surface of the substrate formed in the section (2) along the peripheral edge portion of the substrate surface. After that, a pair of the substrates were overlapped such that the liquid crystal alignment film-formed surfaces faced each other and pressed, and the adhesive was cured. Next, the space between the pair of substrates was filled with nematic liquid crystals (MLC-6221, manufactured by MERCK KGAA) through a liquid crystal pouring port, and then the liquid crystal pouring port was sealed with an acrylic photocuring adhesive. Furthermore, the pair of substrates were heated at 120° C. and then slowly cooled to room temperature in order to remove the flow orientation formed at the time of filling the space with the liquid crystals. Next, polarization plates were attached to both outer surfaces of the substrates, thereby manufacturing a TN-type liquid crystal display element.

(4) Evaluation of Liquid Crystal Alignment Property

A voltage of 5 V was applied as necessary to the liquid crystal display element manufactured in the section (3), and the presence or absence of an abnormal domain during light-dark changes was observed with a microscope (magnification of 50 times), thereby evaluating the liquid crystal alignment property of the liquid crystal display element. The liquid crystal alignment property was evaluated as “favorable” in a case where no abnormal domain was observed and evaluated as “poor” in a case where an abnormal domain was observed. As a result, in this example, the liquid crystal alignment property was evaluated as “favorable”.

(5) Evaluation of Voltage Holding Ratio

A voltage of 5 V was applied to the liquid crystal display element manufactured in the section (3) for 60 microseconds at intervals of 167 milliseconds, and the voltage holding ratio (VHR) after 167 milliseconds from the stopping of the application of the voltage was measured. It should be noted that “VHR-1” manufactured by TOYO Corporation was used as a measuring instrument. The voltage holding ratio was evaluated as “favorable” in a case where VHR was 80% or more and evaluated as “poor” in a case where VHR was less than 80%. As a result, in this example, the voltage holding ratio was evaluated as “favorable”.

### Example 2 and Comparative Example 1

Compositions (C-2 and C-7) were prepared in the same manner as in Example 1 except that, in Example 1, the polymer that was contained in the composition was changed as shown in Table 2 and the total solid solution concentration of the acidic polymer and the basic monomer was changed to 6% by mass. In addition, liquid crystal alignment films were formed using the obtained compositions, respectively, liquid crystal display elements were manufactured, and the liquid crystal alignment properties and the voltage holding ratios were evaluated. The evaluation results are shown in Table 2.

### Example 3

A composition (C-3) was prepared in the same manner as in Example 1 except that, in Example 1, the polymer that was contained in the composition was changed as shown in Table 2 and the total solid solution concentration of the acidic polymer and the basic monomer was changed to 2% by mass, a liquid crystal alignment film was formed, a liquid crystal display element was manufactured, and the liquid crystal alignment property and the voltage holding ratio were evaluated. The evaluation results are shown in Table 2.

### Comparative Example 2

A liquid crystal alignment film was formed in the same manner as in Example 1 except that, in Example 1, the method for preparing the composition was changed as described in (1A), a liquid crystal display element was manufactured, and the liquid crystal alignment property and the voltage holding ratio were evaluated. The evaluation results are shown in Table 2.

(1A) Preparation of Composition

The polymer (PI-1) obtained in Synthesis Example 1 was dissolved in water. The obtained aqueous solution was filtered with a filter having a pore diameter of 0.45 μm, thereby preparing a composition (C-8) in which the solid solution concentration of the polymer was 3% by mass.

### Example 4

A composition (C-4) was prepared in the same manner as in Example 1 except that, in Example 1, the polymerization initiator (I-2) was used instead of the polymerization initiator (I-1). In addition, a liquid crystal display element was manufactured in the same manner as in Example 1 except that a liquid crystal alignment film was formed by a method described in (2B) using the prepared composition (C-4), and the liquid crystal alignment property and the voltage holding ratio were evaluated. The evaluation results are shown in Table 2.

(2B) Formation of Liquid Crystal Alignment Film

The composition (C-4) was heated to 50° C. and then applied to an electrode-formed surface of a transparent substrate including a transparent electrode using a bar coater at a shear speed of 10 cm/s. Next, this substrate was irradiated with 1,000 mJ/cm² of ultraviolet rays including 365 nm bright lines in the normal direction to the substrate under a nitrogen atmosphere using a high-pressure mercury lamp, then, dried with a hot air (50° C.) for five minutes, and, furthermore, heated for 30 minutes in an oven (100° C.) the inside of which was substituted with nitrogen. Therefore, a liquid crystal alignment film having an average film thickness of 0.1 μm was formed on the substrate. This operation was repeated, thereby obtaining a pair of substrates each having the liquid crystal alignment film on the transparent electrode.

### Example 5

A liquid crystal display element was manufactured in the same manner as in Example 1 except that, in Example 1, the composition was prepared and the liquid crystal alignment film was formed in different manners as described in (1C) and (2C), respectively, and the liquid crystal alignment property and the voltage holding ratio were evaluated. The evaluation results are shown in Table 2.

(1C) Preparation of Composition

The polymer (PI-1) obtained in Synthesis Example 1 was dissolved in water, thereby obtaining an aqueous solution. 0.5 Mole equivalent of the thermal base-generating agent (A-1) with respect to the acidic functional group of the polymer (PI-1) was added to and dissolved in the obtained aqueous solution. This aqueous solution was filtered with a filter having a pore diameter of 0.45 μm, thereby preparing a composition (C-5) in which the total solid solution concentration of the polymer and the thermal base-generating agent was 3% by mass.

(2C) Formation of Liquid Crystal Alignment Film

The composition (C-5) prepared in the section (1C) was heated to 50° C. to cause phase transition from a gel phase at room temperature to a liquid crystal phase and then applied to an electrode-formed surface of a transparent substrate including a transparent electrode using a bar coater at a speed of 10 cm/s. Next, this substrate was dried with a hot air (50° C.) for five minutes and then heated for 30 minutes in an oven (230° C.) the inside of which was substituted with nitrogen. Therefore, a liquid crystal alignment film having an average film thickness of 0.1 μm was formed on the substrate. This operation was repeated, thereby obtaining a pair of substrates each having the liquid crystal alignment film on the transparent electrode.

### Example 6

A composition (C-6) was prepared in the same manner as in Example 4 except that, in Example 4, the thermal base-generating agent (A-2) was used instead of the thermal base-generating agent (A-1). In addition, a liquid crystal alignment film was formed using the obtained composition (C-6), a liquid crystal display element was manufactured, and the liquid crystal alignment property and the voltage holding ratio were evaluated. The evaluation results are shown in Table 2.

TABLE 2

| | Composition | | | Liquid crystal display element | |
|---|---|---|---|---|---|
| | | Addi- | Addi- | Liquid crystal | Voltage |
| | Polymer | tive 1 | tive 2 | alignment property | holding ratio |
| Example 1 | (PI-1) | (M-1) | (I-1) | Favorable | Favorable |
| Example 2 | (PI-2) | (M-1) | (I-1) | Favorable | Favorable |
| Example 3 | (PI-4) | (M-1) | (I-1) | Favorable | Favorable |
| Example 4 | (PI-1) | (M-1) | (I-2) | Favorable | Favorable |
| Example 5 | (PI-1) | (A-1) | — | Favorable | Favorable |
| Example 6 | (PI-1) | (A-2) | — | Favorable | Favorable |
| Comparative | (PI-3) | (M-1) | (I-1) | Poor | Favorable |
| Example 1 | | | | | |
| Comparative | (PI-1) | — | — | Favorable | Poor |
| Example 2 | | | | | |

As shown in Table 2, it was found that it was possible to obtain liquid crystal display elements that were favorable in terms of both the liquid crystal alignment property and the voltage holding ratio by forming a liquid crystal alignment film using the composition of any one of Examples 1 to 6. On the other hand, in the case of using the composition of Comparative Example 1 that did not exhibit lyotropic liquid crystallinity, the liquid crystal alignment property was evaluated as “poor”. In addition, in the case of using the composition of Comparative Example 2 that did not contain the compound (A), the voltage holding ratio was low.

### Example 7

(1) Manufacturing of Phase Difference Film

The composition (C-1) prepared in Example 1 was heated to 50° C. and then applied to a TAC film base material using a bar coater at a shear speed of 10 cm/s. Next, this substrate was dried with a hot air (50° C.) for five minutes and then heated for 30 minutes in an oven (100° C.) the inside of which was substituted with nitrogen. Therefore, a liquid crystal alignment film having an average film thickness of 0.1 μm was formed on the substrate. Next, polymerizable liquid crystals (RMS03-013C, manufactured by MERCK KGAA) were filtered with a filter having a pore diameter of 0.45 μm, and then these polymerizable liquid crystals were applied onto the liquid crystal alignment film using the bar coater to form a coating. This coating was dried with a hot air (50° C.) for one minute, and then the substrate was irradiated with 1,000 mJ/cm² of ultraviolet rays including 365 nm bright lines in the normal direction to the substrate using a high-pressure mercury lamp. Therefore, a phase difference film having a liquid crystal layer in which the polymerizable liquid crystals were cured was manufactured.

(2) Evaluation of Liquid Crystal Alignment Property

The liquid crystal alignment property of the phase difference film was evaluated using the phase difference film manufactured in the section (1). The presence or absence of an abnormal domain under crossed Nicols in the phase difference film was observed with a polarization microscope (magnification of 2.5 times). The liquid crystal alignment property was evaluated as “favorable” in a case where no abnormal domain was observed and evaluated as “poor” in a case where an abnormal domain was observed. As a result, in this example, the liquid crystal alignment property was evaluated as “favorable”.

### Example 8

(1) Preparation of Composition

The polymer (PI-1) obtained in Synthesis Example 1 was dissolved in water and ion-exchanged through a strongly acidic cation exchange resin, thereby obtaining an aqueous solution of an acidic polymer in which the counter cation was exchanged from Et₃NH⁺ to H⁺. One mole equivalent of the basic monomer (M-1) with respect to the acidic functional group of the acidic polymer was added to this aqueous solution, then, the polymerization initiator (I-1) was added to and dissolved in the aqueous solution, and furthermore, Biebrich scarlet, which is a water-soluble dichroic pigment, was added to and dissolved in the aqueous solution. The obtained aqueous solution was filtered with a filter having a pore diameter of 0.45 μm, thereby preparing a composition (C-9) in which the total solid solution concentration of the acidic polymer and the basic monomer was 3% by mass, the solid solution concentration of the polymerization initiator was 0.1% by mass, and the solid solution concentration of the dichroic pigment was 6% by mass.

(2) Manufacturing of Polarization Film

The composition (C-9) prepared in the section (1) was heated to 50° C. and then applied to a glass substrate using a bar coater at a shear speed of 10 cm/s. Next, this substrate was dried with a hot air (50° C.) for five minutes and then heated for 30 minutes in an oven (100° C.) the inside of which was substituted with nitrogen. Therefore, a polarization film having an average film thickness of 3 μm was formed on the substrate.

(3) Evaluation of Polarization Properties

The polarization properties of the polarization film were evaluated using the single transmittance (T) and the polarization degree (P) of the polarization film. First, the transmittances of the polarization film in the absorption axis orientation and in the transmission axis orientation were measured, respectively, using a spectrophotometer (V-670, manufactured by JASCO Corporation) in which a Glan Tayler prism polarizer was mounted. The polarization degree of an analyzer was assumed as 100%. The single transmittance (T) was obtained from Expression (b) using the measurement values of the transmittances. The single transmittance (T) was evaluated as “favorable” in a case where the single transmittance (T) of the obtained polarization film was 25% or more and evaluated as “poor” in a case where the single transmittance (T) was less than 25%.

T[%]=(Tp+Tc)/2×100 (b)

In addition, the polarization degree (P) was obtained from Expression (c) using the measurement values of the transmittances. The polarization degree (P) was evaluated as “favorable” in a case where the polarization degree (P) of the polarization film was 50% or more and evaluated as “poor” in a case where the polarization degree (P) was less than 50%.

P[%]={(Tp−Tc)/(Tp+Tc)}5×100 (c)

It should be noted that, in Expressions (b) and (c), Tp is the transmittance of the specimen in the transmission axis orientation and Tc is the transmittance of the specimen in the absorption axis orientation. As a result, in this example, the single transmittance (T) and the polarization degree (P) were both evaluated as “favorable”.

### Example 9

(1) Preparation of Liquid Crystal Composition

A compound shown in Formula (LC-1) was produced according to the method described in Liq. Cryst., 2000, 27(2), 283-287. In addition, a compound shown in Formula (LC-2) was produced according to the method described in International Publication WO 2011/066905. Next, the compound shown in Formula (LC-1) (0.95 g) and the compound shown in Formula (LC-2) (0.05 g) were mixed together, thereby obtaining a liquid crystal composition Q.

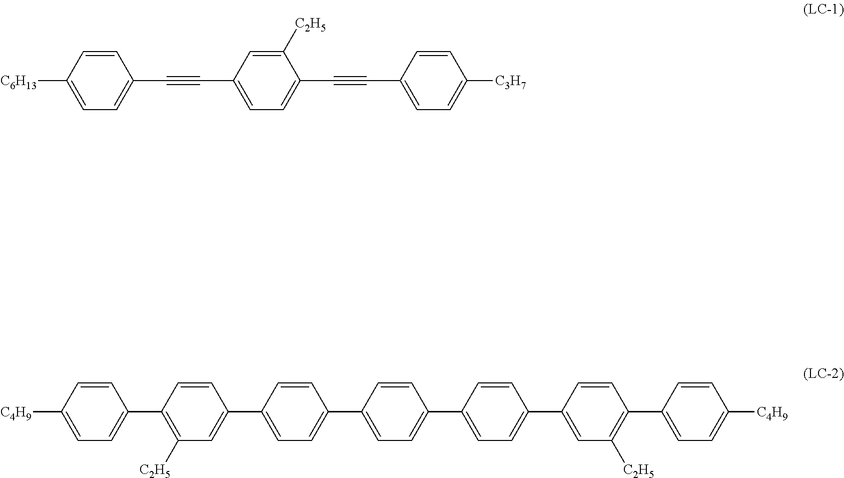

(2) Formation of Liquid Crystal Alignment Film

The composition (C-1) prepared in Example 1 was heated to 50° C. to cause phase transition from a gel phase at room temperature to a liquid crystal phase and then applied to the respective electrode-formed surfaces of a patch substrate 12 and a slot substrate 13 shown in FIG. 4 and FIG. 5 using a bar coater at a speed of 10 cm/s. Next, these substrates were dried with a hot air (50° C.) for five minutes and then heated for 30 minutes in an oven (120° C.) the inside of which was substituted with nitrogen. Therefore, a liquid crystal alignment film having an average film thickness of 0.5 μm was formed on each substrate.

(3) Manufacturing of Array Antenna

A liquid crystal antenna 10 shown in FIG. 4 and FIG. 5 was manufactured. A liquid crystal layer 14 was formed using the liquid crystal composition Q prepared in the section (1), and liquid crystal alignment films (first alignment film 22 and second alignment film 23) were formed in the same manner as in the section (2) using the composition (C-1).

(4) Evaluation of Dielectric Loss Tangent

The dielectric loss tangent (c) was measured under conditions of a temperature of 25° C. and a frequency of 30 GHz using a perturbation-type space resonance device. The dielectric loss tangent was measured at a measurement frequency of 30 GHz and a measurement environment temperature of 25° C. by connecting the array antenna manufactured in the section (3) to a personal computer through the resonance device and a vector network analyzer. The value of the dielectric loss tangent was obtained from the difference between the resonance frequency and the Q value in a case where a specimen was inserted into the resonance device and a case where the specimen was not inserted into the resonance device. The dielectric loss tangent was evaluated as “favorable” in a case where tan 6 was less than 0.0030 and evaluated as “poor” in a case where tan 6 was 0.0030 or more. As a result, in this example, the dielectric loss tangent was evaluated as “favorable”. From this result, it was found that it was possible to obtain a liquid crystal antenna having a small dielectric loss by forming a liquid crystal alignment film using a composition containing the polymer (P), water, and the compound (A).

According to the present disclosure, it is possible, by means of a simple application process, to form an organic film that has excellent performance, such as optical and electrical properties, and exhibits optical anisotropy. In addition, it is possible to evenly align the polymer component in the composition in a large area and to form a liquid crystal alignment film, a phase difference plate, a polarization plate, or the like at a low cost.

What is claimed is:

1. A composition exhibiting lyotropic liquid crystallinity, comprising:
a polymer (P) having an acidic functional group;
water; and
a compound (A) that is at least one selected from a group consisting of a basic monomer and a base-generating agent.

2. The composition according to claim 1, further comprising:
a polymerization initiator,
wherein at least the basic monomer is contained as the compound (A).

3. The composition according to claim 1,
wherein the base-generating agent is a multifunctional compound having a plurality of acidic functional groups that may be protected.

4. The composition according to claim 1,
wherein the polymer (P) is a polymer having a partial structure shown in Formula (0), 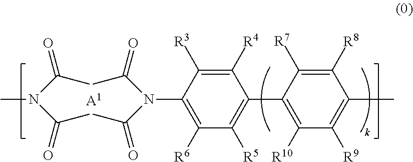
(in Formula (0), A¹ is a partial structure shown in Formula (ar-1) or Formula (ar-2), 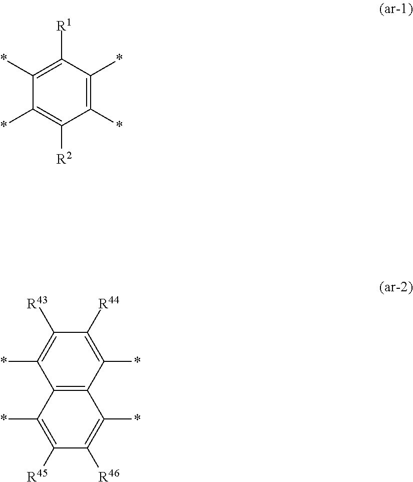
at least one of R¹ to R¹⁰ and R⁴³ to R⁴⁶ is a monovalent group having an acidic functional group, remainders are each independently a hydrogen atom, a halogen atom, or a monovalent organic group, and k is 0 or 1; here, Formula (0) has at least one acidic functional group).

5. A composition comprising:
a polymer (P) having a partial structure shown in Formula (0);
water; and
a compound (A) that is at least one selected from a group consisting of a basic monomer and a base-generating agent, 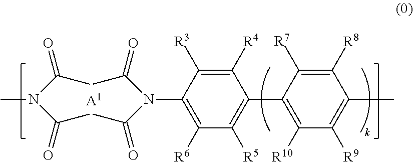
(in Formula (0), A¹ is a partial structure shown in Formula (ar-1) or Formula (ar-2) 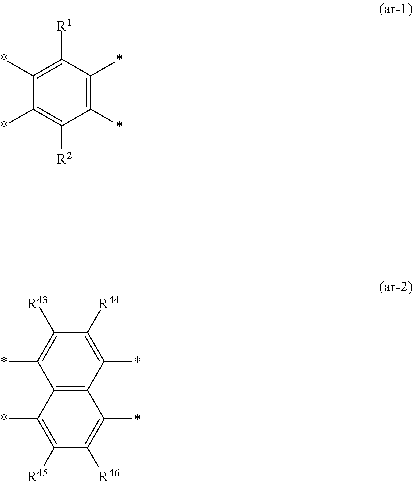
at least one of R¹ to R¹⁰ and R⁴³ to R⁴⁶ is a monovalent group having an acidic functional group, remainders are each independently a hydrogen atom, a halogen atom, or a monovalent organic group, and k is 0 or 1; here, Formula (0) has at least one acidic functional group).

6. The composition according to claim 1,
wherein the polymer (P) is a polymer having a partial structure shown in Formula (1), 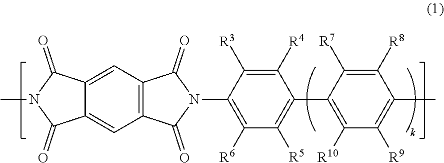
(in Formula (1), at least one of R¹ to R¹⁰ is a monovalent group having an acidic functional group, remainders are each independently a hydrogen atom, a halogen atom, or a monovalent organic group, and k is 0 or 1; here, Formula (1) has at least one acidic functional group).

7. The composition according to claim 1, further comprising:
at least one selected from a group consisting of a dichroic pigment, a pigment aggregate, a quantum rod, a metal nanorod, and a carbon nanotube.

8. A liquid crystal aligning agent exhibiting lyotropic liquid crystallinity, comprising:
a polymer (P) having an acidic functional group;
water; and
a compound (A) that is at least one selected from a group consisting of a basic monomer and a base-generating agent.

9. A method for producing an organic film comprising:
a step of applying the composition according to claim 1 in a liquid crystal phase state onto a base material and drying the composition in a state in which the polymer (P) is aligned.

10. A method for producing a patterned liquid crystal alignment film comprising:
a step of applying a composition that is the composition according to claim 1 containing a photosensitive compound in a liquid crystal phase state onto a base material and drying the composition in a state in which the polymer (P) is aligned to form a liquid crystal alignment film;
a step of exposing a part of the liquid crystal alignment film; and
a step of developing the exposed liquid crystal alignment film.

11. A liquid crystal alignment film formed using the composition according to claim 1.

12. A polarization plate formed using the composition according to claim 1.

13. A phase difference plate comprising:
the liquid crystal alignment film according to claim 11.

14. A liquid crystal antenna that is an array-type liquid crystal antenna having a plurality of antenna units, comprising:
the liquid crystal alignment film according to claim 11.

15. A liquid crystal element comprising:
the liquid crystal alignment film according to claim 11.

16. The composition according to claim 2,
wherein the base-generating agent is a multifunctional compound having a plurality of acidic functional groups that may be protected.

17. The composition according to claim 2,
wherein the polymer (P) is a polymer having a partial structure shown in Formula (0), 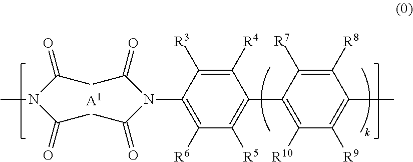
(in Formula (0), A¹ is a partial structure shown in Formula (ar-1) or Formula (ar-2), 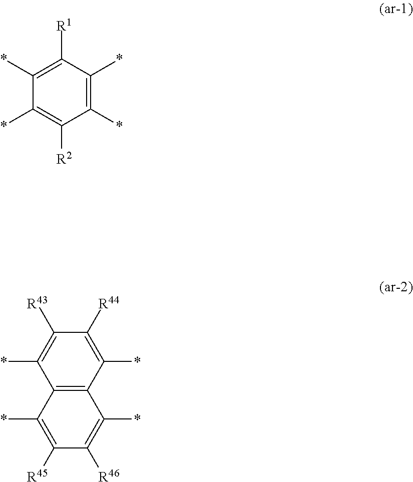
at least one of R¹ to R¹⁰ and R⁴³ to R⁴⁶ is a monovalent group having an acidic functional group, remainders are each independently a hydrogen atom, a halogen atom, or a monovalent organic group, and k is 0 or 1; here, Formula (0) has at least one acidic functional group).

18. The composition according to claim 3,
wherein the polymer (P) is a polymer having a partial structure shown in Formula (0), 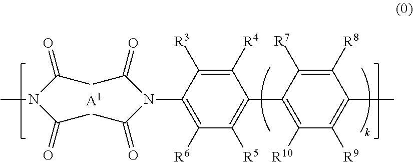
(in Formula (0), A¹ is a partial structure shown in Formula (ar-1) or Formula (ar-2), 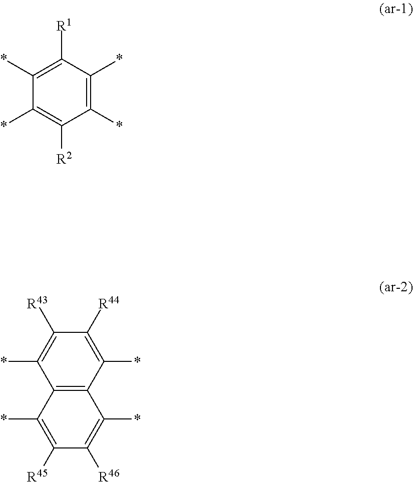
at least one of R¹ to R¹⁰ and R⁴³ to R⁴⁶ is a monovalent group having an acidic functional group, remainders are each independently a hydrogen atom, a halogen atom, or a monovalent organic group, and k is 0 or 1; here, Formula (0) has at least one acidic functional group).

19. The composition according to claim 5,
wherein the polymer (P) is a polymer having a partial structure shown in Formula (1), 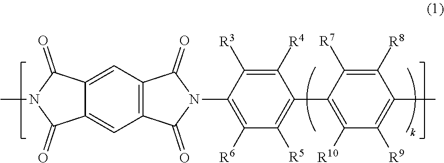
(in Formula (1), at least one of R¹ to R¹⁰ is a monovalent group having an acidic functional group, remainders are each independently a hydrogen atom, a halogen atom, or a monovalent organic group, and k is 0 or 1; here, Formula (1) has at least one acidic functional group).

20. The composition according to claim 5, further comprising:
at least one selected from a group consisting of a dichroic pigment, a pigment aggregate, a quantum rod, a metal nanorod, and a carbon nanotube.
